(19) United States
(12) Patent Application Publication
(10) Pub. No.: US 2026/0067557 A1
(43) Pub. Date: Mar. 5, 2026

(54) IMAGING APPARATUS AND VIDEO EDITING APPARATUS

(71) Applicant: Panasonic Intellectual Property Management Co., Ltd., Osaka (JP)

(72) Inventor: Koichi OTSUKA, Osaka (JP)

(73) Assignee: Panasonic Intellectual Property Management Co., Ltd., Osaka (JP)

(21) Appl. No.: 19/316,402

(22) Filed: Sep. 2, 2025

(30) Foreign Application Priority Data
Sep. 4, 2024 (JP) 2024-152472

(51) Int. Cl. H04N 23/62; G11B 27/031

(52) U.S. Cl. CPC H04N 23/62; G11B 27/031

(57) ABSTRACT

An imaging apparatus includes: an image sensor that captures a subject image to generate image data; a controller that causes a display to display a captured image indicated by the image data to control image shooting; and a user interface that inputs a user operation adjusting a trimming frame indicating a range to be trimmed in the captured image. The controller sets positions and sizes of a plurality of trimming frames according to the user operation input via the user interface, the plurality of trimming frames having respective aspect ratios, and displays the plurality of trimming frames at the set positions and sizes on the captured image on the display.

### TECHNICAL FIELD

The present disclosure relates to an imaging apparatus and a video editing apparatus that capture an image to be trimmed.

### BACKGROUND ART

JP 2013-090240 A discloses a camera in which a user can select a trimming frame to be recorded in association with captured image data from a plurality of trimming frames each defining a trimming range. The camera of JP 2013-090240 A switches between the plurality of trimming frames to display the selected trimming frame to be superimposed on a live view image. The position and size of each trimming frame are defined in advance with respect to the center of a field of view. In this camera, the position and size of the displayed trimming frame selected by the user can be changed. This allows the user to determine the composition after selecting the trimming frame while confirming the relationship with the subject.

### SUMMARY

The present disclosure provides an imaging apparatus and a video editing apparatus that can facilitate performing image shooting of an image to be trimmed.

In one aspect of the present disclosure, an imaging apparatus includes: an image sensor that captures a subject image to generate image data; a controller causes a display to display a captured image indicated by the image data to control image shooting; and a user interface that inputs a user operation adjusting a trimming frame indicating a range to be trimmed in the captured image. The controller sets positions and sizes of a plurality of trimming frames according to the user operation input via the user interface, the plurality of trimming frames having respective aspect ratios, and displays the plurality of trimming frames at the set positions and sizes on the captured image on the display.

In another aspect of the present disclosure, an imaging apparatus includes: an image sensor that captures a subject image to generate image data; a controller causes a display to display a captured image indicated by the image data to control image shooting; and a user interface that inputs a user operation adjusting a trimming frame indicating a range to be trimmed in the captured image. The user interface receives a touch operation on the captured image displayed on the display. The controller sets positions and sizes of one or more trimming frames according to the user operation input via the user interface. The controller displays the one or more trimming frames at the set positions and sizes on the captured image on the display. The controller updates at least one of a position or a size of a particular trimming frame of the one or more trimming frames displayed on the display, according to a touch operation on the particular trimming frame. The controller sets a focus target by an autofocus operation in the image shooting according to a touch operation on an area different from the one or more trimming frames on the captured image.

In one aspect of the present disclosure, a video editing apparatus includes: a communication circuitry that performs data communication with an imaging apparatus that captures a moving image; and a controller that receives moving image data indicating a result of moving image shooting from the imaging apparatus via the communication circuitry and causes a display to display the moving image indicated by the received moving image data. The received moving image data includes meta information managing a position and a size set to each of a plurality of trimming frames each indicating a range to be trimmed in the moving image. The controller causes the display to display the plurality of trimming frames on the moving image at the position and size set to each of the plurality of trimming frames, based on the meta information. The controller generates trimmed moving image data based on the position and the size set to each of the plurality of trimming frames, the trimmed moving image data indicating a moving image trimmed according to one or more trimming frames in the plurality of the trimming frames from the received moving image data.

In another aspect of the present disclosure, an imaging apparatus that captures a moving image includes: an image sensor that captures a subject image at a predetermined frame cycle to generate image data; a controller that causes a display to display a captured image indicated by the image data to control moving image shooting by the imaging apparatus; and a user interface that inputs a user operation adjusting a trimming frame indicating a range to be trimmed in the captured image. The controller causes the display to display a plurality of trimming frames superimposed on the captured image with the moving image shooting being performed, and changes one or more trimming frames in the plurality of trimming frames displayed on the display, according to the user operation input via the user interface.

In another aspect of the present disclosure, an imaging apparatus that captures a moving image includes: an image sensor that captures a subject image at a predetermined frame cycle to generate image data; a controller that causes a display to display a captured image indicated by the image data to control moving image shooting by the imaging apparatus; a user interface that inputs a user operation adjusting a trimming frame indicating a range to be trimmed in the captured image; and a tracker that tracks a subject indicated by the subject image in the moving image shooting. The controller causes the display to display a plurality of trimming frames superimposed on the captured image with the moving image shooting being performed. The controller changes one or more trimming frames in the plurality of trimming frames displayed on the display, according to a position and a size of the subject tracked by the tracker in the captured image.

According to the imaging apparatus and the video editing apparatus of the present disclosure, it is possible to facilitate performing image shooting of an image to be trimmed.

### BRIEF DESCRIPTION OF DRAWINGS

FIG. 1 is a diagram illustrating a configuration of a video production system according to a first embodiment of the present disclosure;

FIG. 2 is a diagram illustrating a configuration of a digital camera in the video production system;

FIG. 3 is a view illustrating a back surface of the digital camera;

FIG. 4 is a diagram illustrating a configuration of a PC in the video production system;

FIG. 5 is a diagram for explaining an outline of an operation in the digital camera of the first embodiment;

FIGS. 6A and 6B are diagrams for explaining a trimming frame setting function in the digital camera;

FIG. 7 is a diagram for explaining a size/position change screen in the digital camera;

FIG. 8 is a flowchart illustrating an operation in a standby state for image shooting in the digital camera;

FIG. 9 is a flowchart illustrating size/position change processing in the digital camera;

FIGS. 10A and 10B are diagrams for explaining a size change operation on a trimming frame;

FIGS. 11A and 10B are diagrams for explaining a position change operation on a trimming frame;

FIG. 12 is a flowchart illustrating recording processing in the digital camera of the first embodiment;

FIG. 13 is a flowchart illustrating video editing processing in the PC of the first embodiment;

FIGS. 14A and 14B are diagrams for explaining a function of a trimming frame mask in the digital camera;

FIGS. 15A to 15D are diagrams for explaining a custom setting function of an aspect ratio in the digital camera;

FIG. 16 is a flowchart illustrating recording processing in a digital camera of a second embodiment;

FIG. 17 is a flowchart illustrating moving image reproduction processing in a PC of the second embodiment;

FIGS. 18A and 18B are diagrams for explaining association of size change in a plurality of trimming frames according to a first modification of the second embodiment;

FIGS. 19A and 19B are diagrams for explaining association of position change in the plurality of trimming frames according to the first modification of the second embodiment; and

FIG. 20 is a diagram illustrating a configuration of a digital camera according to a second modification of the second embodiment.

### DETAILED DESCRIPTION

Embodiments will be described in detail below with reference to the drawings as appropriate. However, unnecessarily detailed description may be omitted. For example, a detailed description of already well-known matters and an overlapping description for substantially the same configuration may be omitted. This is to avoid the following description from becoming unnecessary redundant and to facilitate understanding by those skilled in the art. It should be noted that the inventor provides the accompanying drawings and the following description for a person skilled in the art to fully understand the present disclosure. Thus, the drawings and the description are not intended to limit the subject matter defined in the claims.

### First Embodiment

In a first embodiment of the present disclosure, a moving image creation system to capture a moving image and edit the captured moving image will be described.

### 1. Configuration

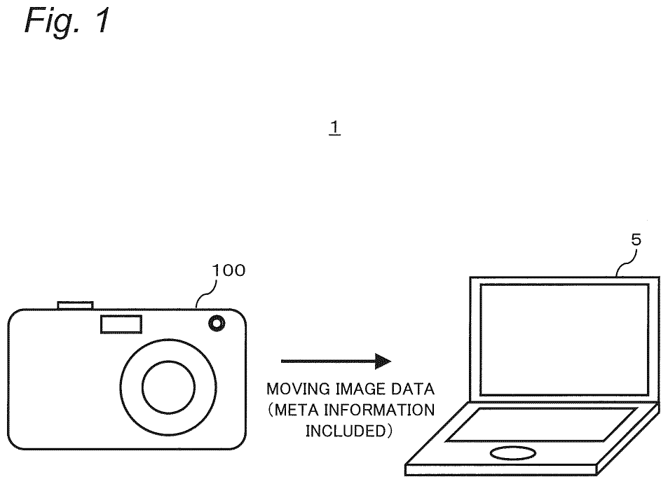

The video production system according to the first embodiment of the present disclosure will be described with reference to FIG. 1.

As illustrated in FIG. 1, for example, a video production system 1 of the present embodiment includes a digital camera 100 and a personal computer (PC) 5 for moving image (video) editing. In the present system 1, the digital camera 100 and the PC 5 are connected to communicate data by wired communication or wireless communication, for example.

The present system 1 is applicable to, for example, an application in which a user shoots one moving image with the digital camera 100 and edits the one moving image to a plurality of moving images having different aspect ratios by trimming. The present system 1 provides a function of uploading the edited moving image to an information distribution platform such as various kinds of social media by the PC 5 connected to a communication network such as the Internet.

In the present system 1, the digital camera 100 records moving image data including various kinds of meta information such as an aspect ratio set in moving image shooting based on a result of the moving image shooting. The moving image data recorded by the digital camera 100 is transferred to the PC 5 by, for example, data communication, and edited in the PC 5 in accordance with the platform of the upload destination. Data from the digital camera 100 may be input to the PC 5 via a portable recording medium such as a memory card. The digital camera 100 and the PC 5 may perform data communication via an access point or via the communication network such as the Internet.

### 1-1. Configuration of Digital Camera

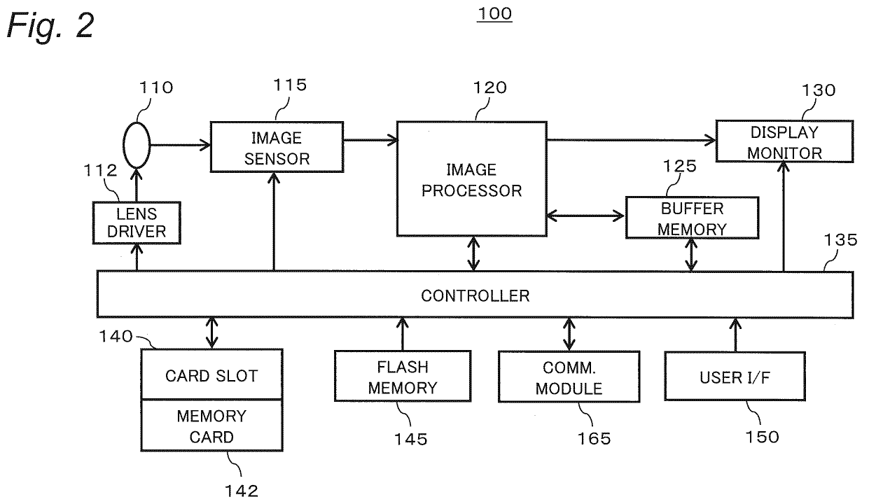

A configuration of a digital camera according to the present embodiment will be described with reference to FIG. 2.

FIG. 2 is a diagram illustrating a configuration of the digital camera 100 in the present system 1. The digital camera 100 is an example of an imaging apparatus in the present embodiment. The digital camera 100 illustrated in FIG. 1 includes an image sensor 115, an image processing engine 120, a display monitor 130, and a controller 135. Further, the digital camera 100 includes a buffer memory 125, a card slot 140, a flash memory 145, a user interface 150, and a communication module 165.

Furthermore, the digital camera 100 includes, for example, an optical system 110 and a lens driver 112. The optical system 110 and the lens driver 112 may constitute an interchangeable lens detachable from the main body of the digital camera 100.

The optical system 110 includes a focus lens, a zoom lens, an optical image stabilizer (OIS), an aperture diaphragm, a shutter, and the like. The focus lens is a lens for changing a focus state of a subject image formed on the image sensor 115. The zoom lens is a lens for changing magnification of a subject image formed by the optical system. Each of the focus lens and the like is configured using one or more lenses.

The lens driver 112 drives the focus lens and the like in the optical system 110. The lens driver 112 includes a motor, to move the focus lens along the optical axis of the optical system 110 under the control of the controller 135. A configuration for driving the focus lens in the lens driver 112 can be implemented with a DC motor, a stepping motor, a servo motor, an ultrasonic motor, or the like.

The image sensor 115 captures a subject image formed via the optical system 110 to generate imaging data. The imaging data constitutes image data indicating an image captured by the image sensor 115. The image sensor 115 generates image data of a new frame at a predetermined frame rate (e.g., 30 frames/second). The generation timing of the imaging data and an electronic shutter operation in the image sensor 115 are controlled by the controller 135. As the image sensor 115, various image sensors such as a CMOS image sensor, a CCD image sensor, or an NMOS image sensor can be used.

The image sensor 115 performs an operation to capture a still image, a moving image, or a through image, and the like. The through image is mainly a moving image, and is displayed on the display monitor 130 in order for the user to determine a composition for shooting a still image and a moving image for recording. The image sensor 115 is an example of an image sensor in the present embodiment. The through image is an example of a captured image in the present embodiment.

The image processing engine 120 performs various processing on the imaging data output from the image sensor 115 to generate image data, and performs various processing on the image data to generate an image to be displayed on the display monitor 130. Examples of various processing include white balance correction, gamma correction, YC conversion processing, electronic zoom processing, compression processing, expansion processing, and the like, but the various processing are not limited thereto. The image processing engine 120 may be configured using a hard-wired electronic circuit, or may be configured using a microcomputer, a processor, or the like using a program.

The display monitor 130 is an example of a display that displays various types of information. For example, the display monitor 130 displays an image (through image) indicated by image data captured by the image sensor 115 and subjected to image processing by the image processing engine 120. In addition, the display monitor 130 displays a menu screen or the like for a user to make various settings in the digital camera 100. The display monitor 130 can be configured by, for example, a liquid crystal display device or an organic EL device.

The user interface 150 is a collective terms of various user interfaces that receive an operation (instruction) from a user. The user interface 150 includes, for example, a physical button, a lever, a dial, a touch panel, a switch, a joystick, and the like. The user interface 150 also includes virtual buttons and icons displayed on the display monitor 130. A specific example of the user interface 150 will be described later.

The controller 135 integrally controls the entire operation of the digital camera 100. The controller 135 includes a CPU and the like, and the CPU executes a program (software) to realize a predetermined function. The controller 135 may include, instead of the CPU, a processor including a dedicated electronic circuit designed to realize a predetermined function. That is, the controller 135 can be realized by various processors such as a CPU, an MPU, a GPU, a DSU, an FPGA, and an ASIC. The controller 135 may include one or more processors. The controller 135 may be configured on a single semiconductor chip together with the image processing engine 120 and the like.

The buffer memory 125 is a recording medium that functions as a work memory of the image processing engine 120 and the controller 135. The buffer memory 125 is realized by a dynamic random access memory (DRAM) or the like. The flash memory 145 is a non-volatile recording medium. Each of the memories 145 and 125 is an example of a storage in the present embodiment.

The card slot 140 is a module into which a removable memory card 142 is inserted. The memory card 142 can be connected to the card slot 140 electrically and mechanically. The memory card 142 is an external memory including a recording element such as a flash memory therein. The memory card 142 can store data such as image data generated by the image processing engine 120. The digital camera 100 may store image data in a built-in memory. The built-in memory may be the buffer memory 125 or the flash memory 145 described above, or may be provided separately from each of the memories 125 and 145.

The communication module 165 is a module (circuitry) that connects to an external device according to a predetermined communication standard in wired or wireless communication. The predetermined communication standard includes, for example, USB, HDMI (registered trademark), IEEE802.11, Wi-Fi (registered trademark), Bluetooth (registered trademark), and the like. The digital camera 100 can communicate with other devices via the communication module 165.

### 1-1-1. Example of User Interface

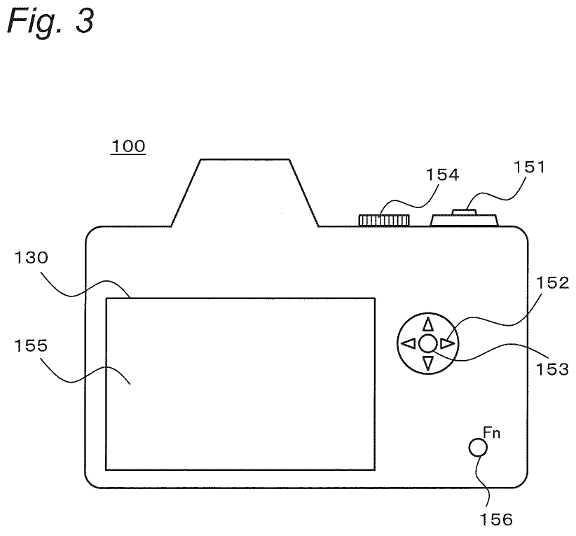

A specific example of the user interface 150 will be described with reference to FIG. 3. FIG. 3 is a view illustrating a back surface of the digital camera 100.

In FIG. 3, a release button 151, selection buttons 152, a determination button 153, a dial 154, a touch panel 155, and a function (Fn) button 156 are illustrated as examples of the user interface 150. When receiving an operation by the user, the user interface 150 transmits various instruction signals to the controller 135.

The release button 151 is a two-stage push type button. When the release button 151 is half-pressed by the user, the controller 135 executes autofocus control (AF control), auto exposure control (AE control), and the like. In addition, when the release button 151 is fully pressed by the user, the controller 135 records image data captured at the timing of the pressing operation as a recorded image in the memory card 142 or the like. In the digital camera 100, a function of starting recording of moving image data by a moving image shooting operation and a function of ending the recording may be allocated to the release button 151. In the user interface 150, the recording of the moving image data may be started and/or ended by a button or the like different from the release button 151.

The selection buttons 152 are push buttons provided in the vertical and horizontal directions. The user can select various condition items displayed on the display monitor 130 or move a cursor by pressing one of the selection buttons 152 in the up, down, left, and right directions.

The determination button 153 is a push button. When the user presses the determination button 153 with the digital camera 100 being in an image shooting mode or a playback mode among various operation modes, the controller 135 displays a menu screen on the display monitor 130. The menu screen is a screen for setting various conditions for image shooting/reproduction. When the determination button 153 is pressed with setting items of various conditions being selected, the controller 135 determines the setting of the selected item.

The dial 154 is rotatably provided. By rotating the dial 154, the user can perform operations such as changing various setting values and the like in the digital camera 100 and switching an operation mode.

The touch panel 155 is disposed to overlap with the display screen of the display monitor 130, and detects a touch operation on the display screen by the user's finger. As a result, the user can perform operations such as designation of an area in the image displayed on the display monitor 130 and various selections on the menu screen. For example, the touch panel 155 enables the user to designate an area corresponding to an AF target such as a subject to be focused by AF control in image shooting by a touch operation on an image.

The Fn button 156 is a push button. In the digital camera 100, by assigning an arbitrary function designated by the user on the menu screen to the Fn button 156, the function can be performed by pressing the Fn button 156.

### 1-2. Configuration of PC

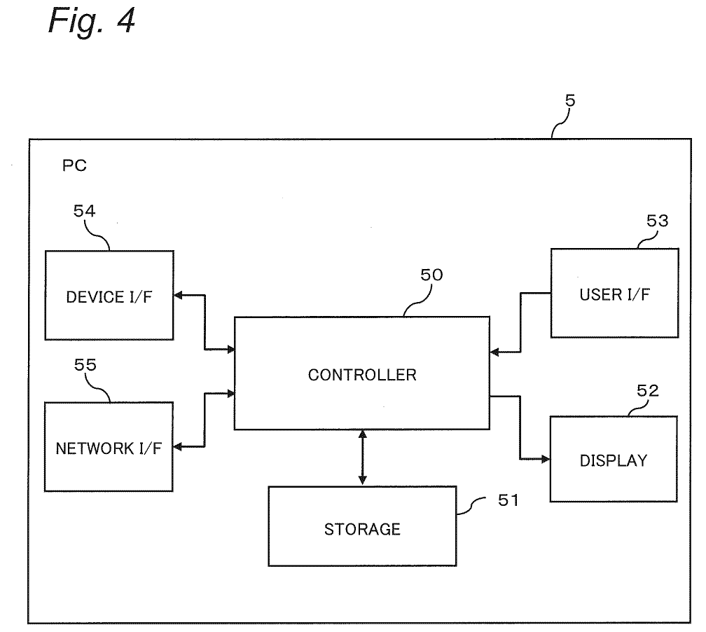

A configuration of the PC 5 in the present embodiment will be described with reference to FIG. 4.

FIG. 4 is a diagram illustrating a configuration of the PC 5 in the present system 1. The PC 5 is an example of a video editing apparatus in the present embodiment. The PC 5 illustrated in FIG. 4 includes a controller 50, a storage 51, a display 52, a user interface 53, a device interface 54, and a network interface 55. Hereinafter, the “interface” is abbreviated as “I/F”.

The controller 50 is electrically connected to each component constituting the PC 5 and controls the operation of each component. The controller 50 includes a CPU and the like, and the CPU executes a program (software) to realize a predetermined function. The controller 50 may be realized only by a hardware circuit exclusively designed to realize a predetermined function. In addition to the CPU, the controller 50 can include various circuits such as an MPU, a GPU, a DSP, an FPGA, or an ASIC. The controller 50 may include an internal memory as a temporary storage area for holding various data and programs.

The storage 51 is a recording medium that stores data, programs, and the like performed for realizing a predetermined function in the PC 5. The storage 51 includes, for example, a hard disk (HDD), a semiconductor storage device (SSD), a semiconductor memory (RAM), or the like. The storage 51 may function as a work area of the controller 50, and may be configured by a storage area in an internal memory of the controller 50. The storage 51 stores, for example, a program for causing the PC 5 to function as the video editing apparatus of the present disclosure. For example, the program is performed by the controller 50, and causes the controller 50 to execute a video editing method including various processing in the PC 5. Furthermore, the storage 51 may store non-linear editing (NLE) software or the like used for video editing in the PC 5.

The display 52 includes, for example, a liquid crystal display or an organic EL display. The display 52 displays a moving image or the like indicated by the moving image data received from the digital camera 100. The display 52 may display various icons for operating the user interface 53, information input from the user interface 53, and the like.

The user interface 53 is a general term for operation members operated by a user. The user interface 53 includes, for example, a keyboard, a mouse, a touch pad, a button, and/or a switch. The user interface 53 may constitute a touch panel together with the display 52. When receiving an operation by the user, the user interface 53 transmits an operation signal according to the user operation to the controller 50.

The device I/F 54 is a circuitry for connecting an external device such as the digital camera 100 to the PC 5. The device I/F 54 performs communication conforming to the USB standard, the Bluetooth standard, or the like. The device I/F 54 of the present embodiment receives various types of information from the external device or transmits various types of information to the external device under the control of the controller 50 by communication conforming to the USB standard, for example. The device I/F 54 is an example of a communication circuitry in the PC 5 of the present embodiment.

The network I/F 55 is a circuitry that performs data communication conforming to the communication standard IEEE802.11, the Wi-Fi standard, or the like. The PC 5 can communicate with other devices directly or via an access point via the network I/F 55. The network I/F 55 may be connectable to a communication network. The network I/F 55 may constitute a communication circuitry in the PC 5 instead of or in addition to the device I/F 54.

### 2. Operation

An operation of the present system 1 configured as described above will be described below.

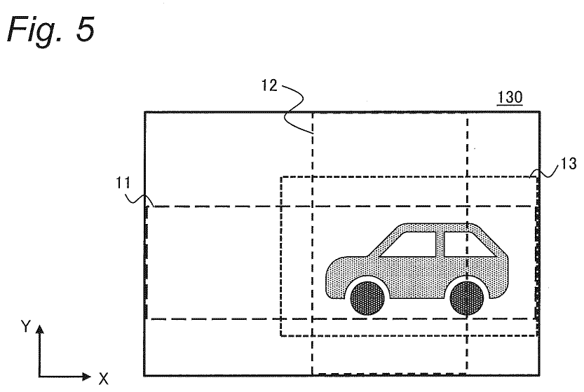

In the present system 1, when performing a moving image shooting, the digital camera 100 performs an operation enabling the user to check a range to be trimmed from the captured moving image by trimming after the image shooting, and to adjust the range. An outline of such an operation in the digital camera 100 of the present embodiment will be described with reference to FIG. 5.

The digital camera 100 displays the through image in real time on the display monitor 130 in the image shooting mode. The digital camera 100 of the present embodiment displays trimming frames 11 to 13 on the image on the live view screen, the trimming frames 11 to 13 being set by a setting menu or the like, for example. Each of the trimming frames 11 to 13 indicates a range to be trimmed from the captured moving image. Hereinafter, a long-side direction on the screen of the display monitor 130 is referred to as an X direction (also referred to as a lateral direction), and a short-length direction is referred to as a Y direction (also referred to as a longitudinal direction).

As illustrated in FIG. 5, the display monitor 130 displays a plurality of trimming frames 11 to 13 on the same screen in different appearances (e.g., frame colors or line types). Each of the trimming frames 11 to 13 is set as a frame indicating an outer edge of an area to be trimmed in a rectangular shape from the image, for example, in accordance with a horizontal to vertical aspect ratio. In the digital camera 100 of the present embodiment, by simultaneously displaying a plurality of trimming frames 11 to 13 on the live view screen, the user can shoot a moving image visually checking a composition or the like obtained after the trimming by each of the trimming frames 11 to 13.

For example, moving image shooting for various platforms can be performed at a time on an assumption that a plurality of moving images trimmed from the image shooting result is generated by the trimming frames 11 to 13 set according to the various platforms as upload destinations of the edited moving images.

The digital camera 100 of the present embodiment receives a user operation adjusting positions and/or sizes of the trimming frames 11 to 13 displayed on the live view screen, for example, in a standby state for image shooting before performing the moving image shooting operation. According to such an adjustment operation, the trimming frames 11 to 13 can be moved or scaled according to the subject and other trimming frames on the live view screen, and the trimming range by each of the trimming frames 11 to 13 can be adjusted. Consequently, it is possible to easily shoot a moving image assuming trimming from the image shooting result.

### 2-1. Setting of Trimming Frame

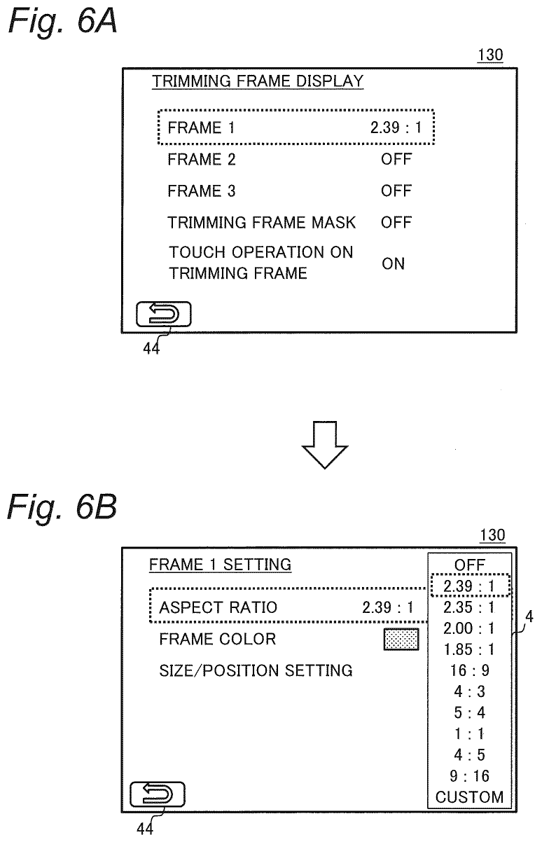

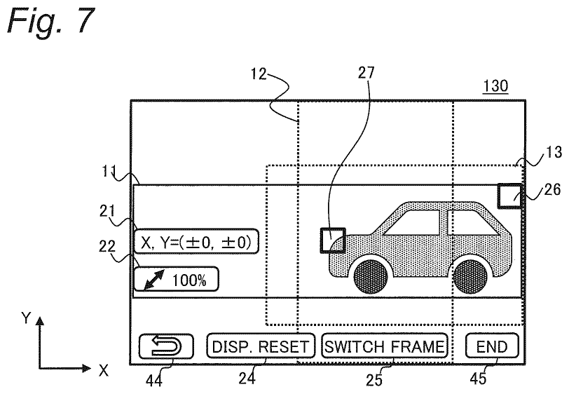

The digital camera 100 of the present embodiment provides a function enabling the user to set the trimming frames 11 to 13 by a setting menu or the like in advance before the moving image shooting operation, for example. An outline of such a setting function will be described below with reference to FIGS. 6A, 6B and 7.

FIGS. 6A and 6B are diagrams for explaining a trimming frame setting function in the digital camera 100. FIG. 6A illustrates a display example of a setting menu screen for setting various types of information related to the trimming frames 11 to 13 in the digital camera 100. As the menu items in the present display example, the display monitor 130 displays “trimming frame mask” and “touch operation on trimming frame” in addition to “frame 1”, “frame 2”, and “frame 3” corresponding to the trimming frames 11, 12, and 13, respectively, for example.

The menu item “trimming frame mask” is provided to set a masking function (described later) for an area outside the frames of the trimming frames 11 to 13 on the live view screen. The “touch operation on trimming frame” sets ON/OFF to enable/disable the touch operation on the frame line of the trimming frames 11 to 13 on the touch panel 155. For example, the digital camera 100 holds setting information indicating such various setting results in the buffer memory 125 or the like.

In this example, the menu item “frame 1” is set to “2.39:1” indicating the aspect ratio of the corresponding trimming frame 11. The menu items of “frame 2” and “frame 3” are set to “OFF” that disables display of the respective corresponding trimming frames 12 and 13. In the present embodiment, the menu items of “frame 1” to “frame 3” are provided so that attributes such as an aspect ratio can be set for the corresponding trimming frames 11 to 13. FIG. 6B illustrates a setting screen of the trimming frame 11 that is displayed when the menu item “frame 1” is selected on the setting menu screen of FIG. 6A.

The display monitor 130 displays “aspect ratio”, “frame color”, and “size/position setting” as menu items on the setting screen illustrated in FIG. 6B. When the menu item “aspect ratio” is selected by the user interface 150, the display monitor 130 displays a selection list 4 in which options such as a plurality of different aspect ratios are arranged. The digital camera 100 sets the trimming frame 11 having the aspect ratio according to the selection result from the selection list 4 as the setting information. “OFF” in the selection list 4 is an option for disabling the display of the trimming frame 11.

The menu item “frame color” is provided so that the color of the frame line can be set as the appearance of the trimming frame 11 on the live view screen. In a case where the menu item “size/position setting” is selected, the display monitor 130 transitions from the setting screen of FIG. 6B to a size/position change screen for adjusting the size and/or position of the trimming frame 11 according to the user operation, for example, as illustrated in FIG. 7. In the present embodiment, the size and position are set to the trimming frame to which the aspect ratio is set.

Further, when the “touch operation on trimming frame” is ON in the setting menu screen illustrated in FIG. 6A, the digital camera 100 of the present embodiment causes the display monitor 130 to transition to the size/position change screen also by a touch operation on any of the trimming frames 11 to 13 on the live view screen. Details of the operation of transitioning to such a size/position change screen will be described later.

In addition, in each of the screens illustrated in FIGS. 6A and 6B, the display monitor 130 displays a return button 44 as a virtual button that receives a return operation by the user. The return operation is a user operation for returning from a transitioned screen to a screen displayed before the transition by a touch operation of the return button 44.

### 2-1-1. Size/Position Setting

Details of the setting function on the size/position change screen, on which the sizes and positions of the trimming frames 11 to 13 can be set in the digital camera 100, will be described with reference to FIG. 7. FIG. 7 is a diagram for explaining the size/position change screen in the digital camera 100.

FIG. 7 illustrates an example in which the screen transitions from the example of FIG. 5 to the size/position change screen by selection of the menu item “size/position setting” on the setting screen for the trimming frame 11 illustrated in FIG. 6B or a touch operation on the trimming frame 11 on the live view screen of FIG. 5. In the present example, the trimming frame 11 is displayed in a mode different from the other trimming frames 12 and 13 as a targeted frame to be changed in size/position.

In the size/position change screen of this example, the display monitor 130 displays a reset button 24, a frame switching button 25, the return button 44, and an end button 45 as virtual buttons in addition to a position display field 21 and a size display field 22. The display monitor 130 further displays a size operation area 26 and a position operation area 27 for the trimming frame 11. The size operation area 26 is an area for inputting a size change operation on the change screen, and the position operation area 27 is an area for inputting a position change operation. The size change operation and the position change operation are user operations for changing the size and position of the targeted frame, and are input by, for example, a drag operation on the touch panel 155.

In an initial state, for example, the trimming frame 11 is displayed such that the center of the frame aligns with the center of the screen and the long side of the frame has the same size as the long side of the screen. The position display field 21 indicates movement amounts of the trimming frame 11 in the X direction and the Y direction in units of pixels with respect to the position in the initial state as a reference point (X=0, Y=0). The size display field 22 indicates a magnification at which the size of the trimming frame 11 is changed from the initial state with respect to the size in the initial state as “100%”. The reset button 24 receives a touch operation for returning the size and position to the initial state.

The frame switching button 25 receives a touch operation for sequentially switching trimming frames selected as the targeted frame to be changed in size and position from the plurality of trimming frames 11 to 13. For example, in accordance with a displayed order of the menu items “frame 1” to “frame 3” on the setting menu screen illustrated in FIG. 6A, when the frame switching button 25 is operated with the trimming frame 11 as illustrated in FIG. 7 being the targeted frame, the targeted frame is switched to the trimming frame 12.

In the present embodiment, for example, when receiving the return operation by the return button 44 on the size/position change screen, the digital camera 100 causes the display monitor 130 to transition to the live view screen without saving the change in size and position. On the other hand, when the touch operation of the end button 45 is input by the touch panel 155, the digital camera 100 determines the change on the size/position change screen, stores the determined change in the buffer memory 125 or the like, and ends the size/position setting function.

In the above example, the digital camera 100 displays the size/position change screen with the trimming frame as the targeted frame by selecting the menu item for each of the trimming frames 11 to 13 or by a touch operation on the live view screen. For example, the digital camera 100 may assign the same function as the selection of the menu item to the Fn button 156 according to the setting by the user, and may perform the screen transition by the user operation of pressing the Fn button 156. In this case, for example, every time the Fn button 156 is pressed, the targeted frame in the trimming frames 11 to 13 may be sequentially switched.

### 2-2. Operation in Standby State for Image Shooting

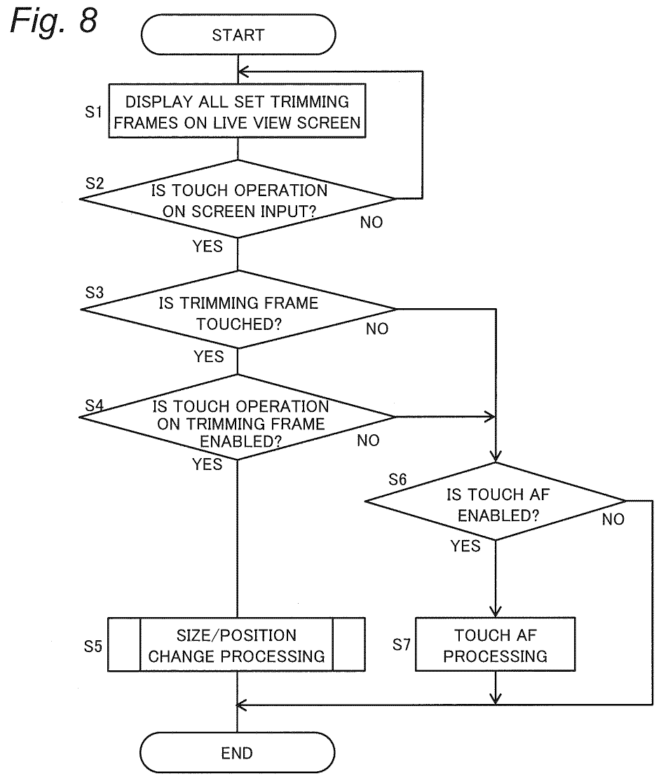

For example, in a standby state for image shooting before performing the moving image shooting operation, the digital camera 100 of the present embodiment performs an operation that achieves both processing of the size/position change processing according to the user operation on the size/position change screen as described above and the AF control processing according to the touch operation on the AF target. Such an operation of the digital camera 100 will be described with reference to FIG. 8.

FIG. 8 is a flowchart illustrating an operation in the standby state for image shooting in the digital camera 100. The processing illustrated in FIG. 8 is started, for example, when the digital camera 100 is set to the image shooting mode. Each processing of FIG. 8 is performed by the controller 135 in a state where the live view screen is displayed on the display monitor 130.

First, the controller 135 displays all of the set trimming frames 11 to 13 and the like on the live view screen on the display monitor 130 as illustrated in FIG. 5, for example, based on the setting information by the above-described setting function (S1). The setting function may be performed at any time in parallel with the processing of this flowchart.

The controller 135 determines whether or not a touch operation on the touch panel 155 is input on the live view screen (S2). When the touch operation is not input (NO in S2), the controller 135 repeats the processing in and after step S1 in a predetermined cycle such as a frame cycle.

When the touch operation is input (YES in S2), the controller 135 determines whether a portion touched by the touch operation on the live view screen is on any frame line of the trimming frames 11 to 13 (S3). The controller 135 determines whether or not such a touched portion is on a frame line based on, for example, positions in the X direction and the Y direction.

When the touched portion is on the frame line (YES in S3), the controller 135 determines whether the setting of the “touch operation on trimming frame” (see FIG. 6A) is ON based on the setting information, that is, whether the touch operation is set to be valid (S4).

When the setting of the “touch operation on trimming frame” is ON (YES in S4), the controller 135 causes the display monitor 130 to transition from the live view screen to the size/position change screen, and performs the size/position change processing (S5). The controller 135 displays the size/position change screen with the trimming frame corresponding to the touched portion among the trimming frames 11 to 13 displayed on the live view screen in step S1 as the targeted frame. Details of the size/position change processing will be described later.

On the other hand, when the touched portion is not on any frame line of the trimming frames 11 to 13 (NO in S3), the controller 135 determines whether a setting of the AF control by the touch operation on the AF target is ON, based on the setting information (S6). In the digital camera 100 of the present embodiment, for example, validity/invalidity of the touch AF can be set by ON/OFF using the user interface 150 in a setting menu or the like.

When the setting of the “touch operation on trimming frame” is not ON (NO in S4) even when the touched portion is on the frame line (YES in S3), the controller 135 performs the determination in step S6.

When the touch AF setting is ON (YES in S6), the controller 135 performs the AF control according to the touched portion (S7). In such touch AF processing, for example, a focus lens of the optical system 110 is driven by the lens driver 112 with a subject appearing in an area corresponding to the touched portion in the through image as the AF target.

After executing the size/position change processing (S5) or the touch AF processing (S7), the controller 135 ends the processing of this flowchart. When the touch AF setting is not ON (NO in S6), the controller 135 also ends the processing of this flowchart. Thereafter, the controller 135 repeats the processing of this flowchart at a predetermined cycle such as a frame rate, for example.

According to the above processing, all the set trimming frames 11 to 13 are displayed on the live view screen (S1), and the size/position change processing can be performed (S5) according to the touch operation touching any frame line on the screen (S2 to S4). Therefore, for example, the size/position change processing can be efficiently performed without going through the setting menu screen or the like from the live view screen, and the user can intuitively specify the targeted frame.

Furthermore, in the present embodiment, with the setting of the “touch operation on trimming frame” being ON (YES in S4), when the touch operation on the frame line is input (YES in S3), the size/position change processing is performed without depending on the touch AF setting (S5). Therefore, the size/position change processing can be performed in preference to the touch AF processing, with respect to the touch operation on the frame line. For example, the trimming frames 11 to 13 are each set to surround the subject, and a tendency is expected that the touch operation on the AF target is input on an area within the frame. In the present embodiment, by performing the touch AF processing by a touch operation other than the frame line (NO in S3, S7), both the touch AF processing and size/position change processing each in response to the touch operation on the live view screen can be performed alternately and used in combination.

The example in which all the trimming frames 11 to 13 in the setting information are displayed on the live view screen is described above (S1). For example, when the screen transitions to the size/position change screen by selecting a menu item from the setting screen of each trimming frame (see FIG. 6B), only the targeted trimming frame to be changed may be displayed on the live view screen.

### 2-3. Size/Position Change Processing

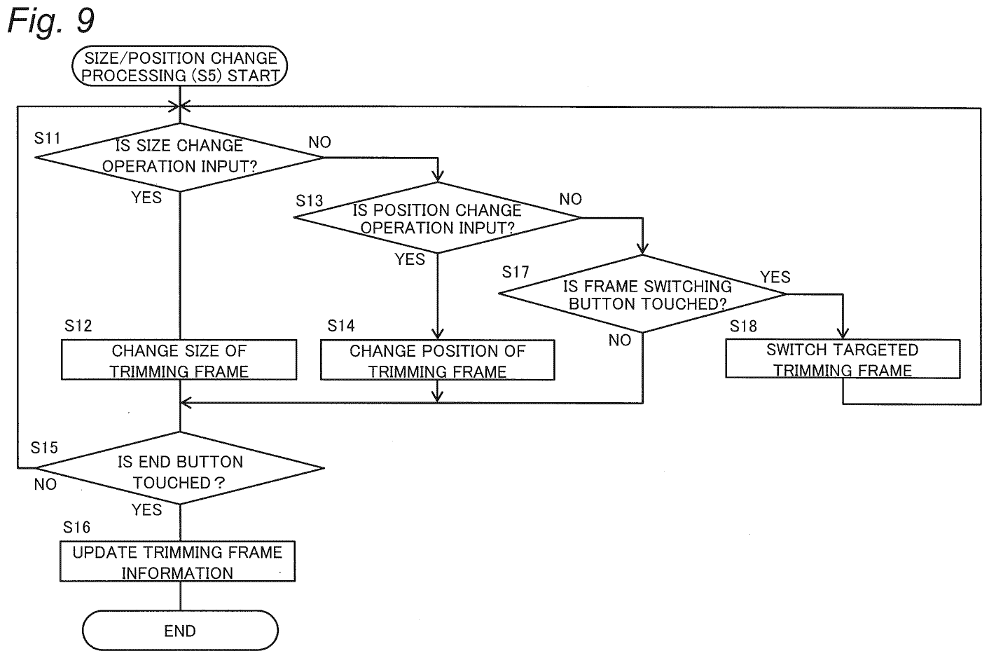

Details of the size/position change processing in step S5 of FIG. 8 will be described with reference to FIGS. 9 to 11A and 11B.

FIG. 9 is a flowchart illustrating size/position change processing in the digital camera 100. The processing of this flowchart is started in a state in which one of the trimming frames 11 to 13 is selected as the targeted frame by a touch operation of a frame line or the like, and the size/position change screen is displayed on the display monitor 130, for example. Hereinafter, an example in which the trimming frame 11 is selected will be described.

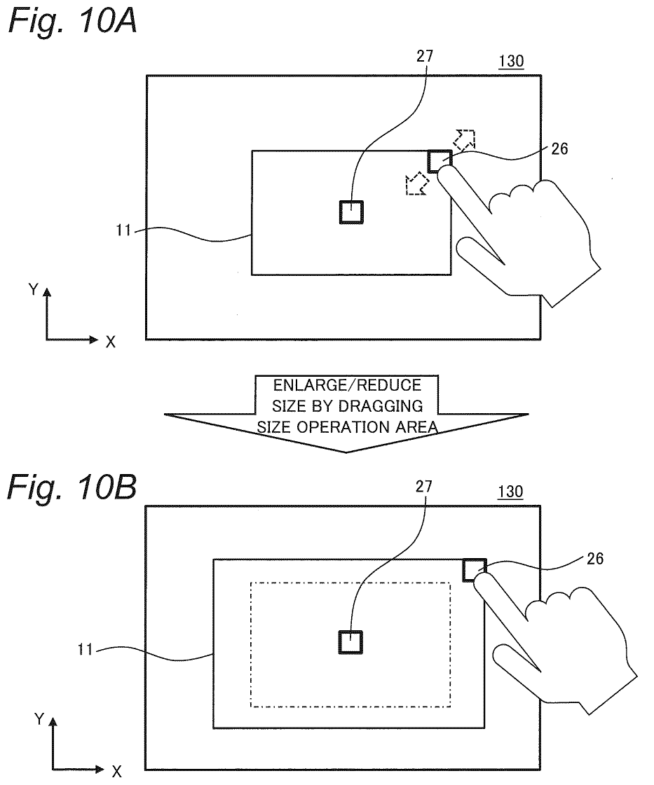

First, the controller 135 determines whether a size change operation to be changed is input on the user interface 150 (S11). FIGS. 10A and 10B are diagrams for explaining a size change operation on a trimming frame.

For example, as illustrated in FIG. 10A, the user interface 150 inputs a user operation of dragging the size operation area 26 in a diagonal direction of the screen on the display monitor 130 as the size change operation on the touch panel 155. FIG. 10B illustrates an example in which the size of the trimming frame 11 is enlarged by such a drag operation of the size operation area 26 from the state illustrated in FIG. 10A. In this example, the size is enlarged by a drag operation in a direction away from the center of the trimming frame 11, and the size is reduced by a drag operation in a direction approaching the center. The size change operation may be, for example, a user operation of rotating the dial 154. For example, the size of the trimming frame 11 may be enlarged or reduced according to the rotation direction of the dial 154.

When the size change operation is input (YES in S11), the controller 135 changes the size of the trimming frame 11 according to the input operation (S12). For example, the controller 135 updates the display of the trimming frame 11 and the size display field 22 on the size/position change screen (see FIG. 7) on the display monitor 130 to the changed size. The changeable size may be provided with a predetermined lower limit value (e.g., “20%” of the initial state and the like). When the size according to the position change operation is less than the lower limit value, the controller 135 may change the size of the trimming frame 11 to the lower limit value.

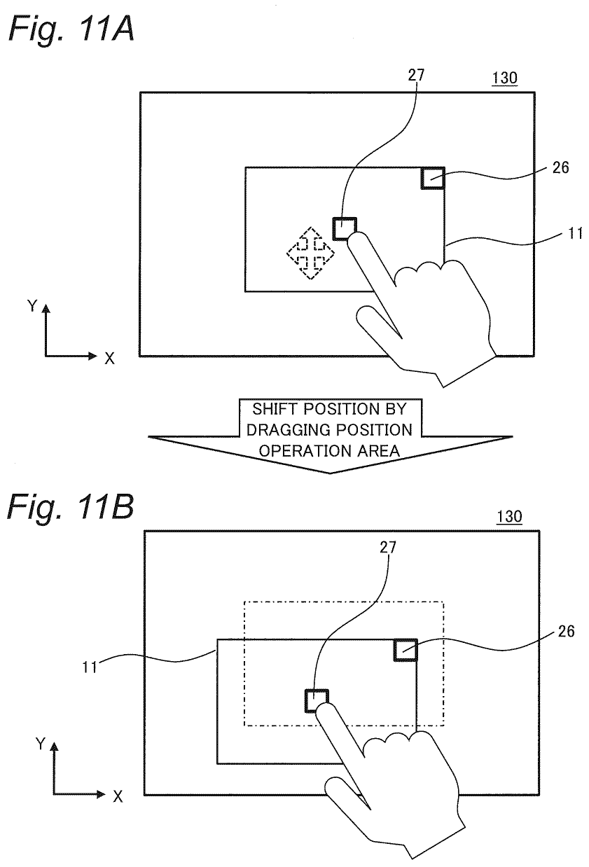

When the size change operation is not input (NO in S11), the controller 135 determines whether the position change operation on the targeted frame is input on the user interface 150 (S13). FIGS. 11A and 11B are diagrams for explaining a position change operation on a trimming frame.

For example, as illustrated in FIG. 11A, the user interface 150 inputs a user operation of dragging the position operation area 27 on the screen of the display monitor 130 as the position change operation on the touch panel 155. FIG. 11B illustrates an example in which the trimming frame 11 is moved in the −X direction and the −Y direction by the drag operation of the position operation area 27 from the state illustrated in FIG. 11A. In this example, the position of the trimming frame 11 is changed so that the position where the position operation area 27 is moved by the drag operation is set as the center of the trimming frame 11. The position change operation may be a user operation of pressing one of the selection buttons 152 in the up, down, left, and right directions, or may be input by a joystick of the user interface 150.

When the position change operation is input (YES in S13), the controller 135 changes the position of the trimming frame 11 according to the input operation (S14). For example, the controller 135 updates the display of the trimming frame 11 and the position display field 21 on the size/position change screen of the display monitor 130 to the changed position.

After the size of the trimming frame is changed (S12) or the position of the trimming frame 11 is changed (S14), the controller 135 determines whether a touch operation of the end button 45 is input on the touch panel 155 (S15).

When the touch operation of the end button 45 is input (YES in S15), the controller 135 updates trimming frame information on the trimming frame 11 to be changed according to the change in steps S12 and S14 (S16). The trimming frame information indicates information set to each of the trimming frames 11 to 13 among the setting information held in the buffer memory 125 or the like, and includes the aspect ratio, the size, and the position of each of the trimming frames, for example.

When the touch operation of the end button 45 is not input (NO in S15), the controller 135 repeats the processing in and after step S11 for the trimming frame 11 to be changed, for example.

When the position change operation is not input (NO in S13), the controller 135 determines whether or not a touch operation of the frame switching button 25 is input on the touch panel 155, for example (S17). When the touch operation on the frame switching button 25 is not input (NO in S17), the controller 135 performs the determination in step S15 according to the touch operation of the end button 45.

When the touch operation on the frame switching button 25 is input (YES in S17), the controller 135 switches the targeted frame in the trimming frames 11 to 13 (S18). In the present example, the controller 135 switches the targeted frame from the trimming frame 11 to the trimming frame 12, and updates the size/position change screen on the display monitor 130. After the switching, the controller 135 repeats the processing in and after step S11 for the trimming frame 12.

According to the touch operation of the end button 45 (S15), after updating the trimming frame information (S16), the controller 135 ends the processing of this flowchart, and returns to step S1 in FIG. 8. In this way, the trimming frames 11 to 13 are displayed on the live view screen based on the setting information including the updated trimming frame information (S1), and the relationship between the positions and the sizes of the set trimming frames 11 to 13 can be visualized to the user, for example.

According to the above processing, the size and/or position of the targeted frame selected from the trimming frames 11 to 13 can be changed according to the user operation on the size/position change screen illustrated in FIG. 7.

In the above processing, when a touch operation on the return button 44 on the size/position change screen is input, the controller 135 ends the processing of this flowchart without updating the trimming frame information (S16), and returns to step S1 in FIG. 8. In this case, changes in size and position are not saved. When a touch operation of the reset button 24 is input, the controller 135 resets the size and position to the initial state and continues the processing of this flowchart.

### 2-4. Recording of Trimming Frame Information

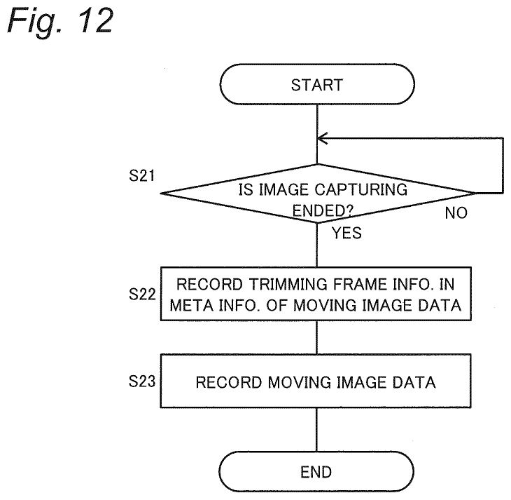

The digital camera 100 of the present embodiment records the trimming frame information on the trimming frames 11 to 13 adjusted before the moving image shooting operation by the size/position change processing as described above in association with the moving image of the image shooting result. Such recording processing in the digital camera 100 will be described with reference to FIG. 12.

FIG. 12 is a flowchart illustrating recording processing in the digital camera 100 of the present embodiment. The processing of this flowchart is started together with the moving image shooting operation by the full-press operation of the release button 151, for example, and each processing is performed by the controller 135 of the digital camera 100.

For example, the controller 135 determines whether or not the capturing operation is ended according to whether or not the full-press operation of the release button 151 is input during the execution of the moving image shooting operation (S21).

When the capturing operation is ended (YES in S21), the controller 135 records the latest trimming frame information, which is held in the buffer memory 125 in the meta information of the moving image data indicating the moving image of the image shooting result (S22). The meta information in the moving image data manages a position and a size set for each of the trimming frames 11 to 13 in association with the image shooting result as header information including various types of information such as settings at the time of the image shooting. The meta information may be recorded according to an extended format of Exif (Exchangeable image file format), for example.

The controller 135 records the moving image data including the meta information, the moving image data being generated from the image shooting result and recorded in the memory card 142 (S23). Thereafter, the controller 135 ends the processing of this flowchart.

According to the above processing, when the moving image shooting operation is ended, the moving image data can be recorded by associating the trimming frame information on the trimming frames 11 to 13 whose sizes and/or positions are adjusted by the size/position change processing in the standby state for image shooting as the meta information. For example, in the video production system 1 of the present embodiment, moving image data including such meta information is transferred from the digital camera 100 after the moving image shooting to the PC 5 via the communication module 165. The operation of the PC 5 in the present system 1 will be described below.

### 2-5. Video Editing Processing

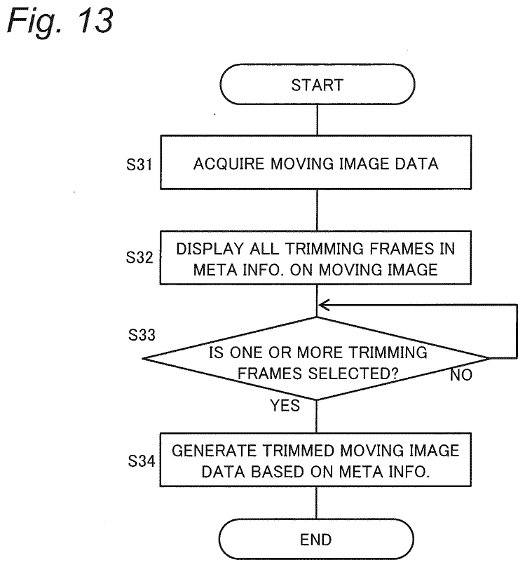

The PC 5 of the present system 1 performs video editing processing such as trimming of a moving image captured by the digital camera 100. FIG. 13 is a flowchart illustrating the video editing processing in the PC 5 of the present embodiment. The processing of this flowchart is started, for example, according to a predetermined user operation calling a video editing function in the PC 5. Each processing in FIG. 13 is performed by the controller 50 of the PC 5.

First, the controller 50 acquires moving image data recorded in the memory card 142 from the digital camera 100 connected via the device I/F 54, for example (S31). The moving image data is held in the storage 51 or the like. The controller 50 may acquire moving image data via a communication network by the network I/F 55. In the digital camera 100, the moving image data generated as a result of capturing a moving image may be transmitted to the PC 5 in addition to or instead of being recorded in the memory card 142.

Next, based on the acquired moving image data, the controller 50 causes the display 52 to display all the trimming frames 11 to 13 recorded in the meta information so that the trimming frames 11 to 13 are superimposed on the moving image indicated by the moving image data (S32).

The controller 50 determines whether or not a trimming frame is selected based on whether or not a user operation selecting one or more of the trimming frames 11 to 13 displayed on the display 52 is input in the user interface 53 (S33). When the trimming frame is not selected (NO in S33), the controller 50 repeats the determination in step S33 at a predetermined cycle, for example. In a case where the user operation is not input until the reproduction of the moving image ends, the controller 135 may end the processing of this flowchart without performing the subsequent processing.

When the trimming frame is selected (YES in S33), for example, based on the position and size of the trimming frame in the meta information, the controller 50 generates trimmed moving image data indicating a moving image trimmed according to the trimming frame from captured the moving image (S34). When two or more trimming frames are selected, the controller 50 generates trimmed moving image data according to each trimming frame.

After generating the trimmed moving image data (S34), the controller 50 ends the processing of this flowchart.

According to the above processing, the trimming frames 11 to 13 displayed in the moving image shooting can be displayed when the moving image is reproduced in the PC 5, the moving image being indicated by the moving image data acquired from the digital camera 100 where the moving image shooting is performed. For example, even when the user does not remember the trimming frames 11 to 13 at the time of shooting the moving image, the intended composition can be reproduced by the display of the trimming frames 11 to 13 in moving image reproduction, and this facilitates video editing of the moving image. Furthermore, even when a photographer and an editor of the moving image are different, the video production system 1 can facilitate the video editing by displaying the trimming frames 11 to 13 using the meta information as above.

Furthermore, the trimmed moving image data from the captured moving image can be generated according to the trimming frames 11 to 13 displayed at the time of the image shooting, and the video editing for producing a moving image having a composition intended by the user can be efficiently performed. Further, trimmed moving image data can be generated by one or more trimming frames selected by the user from the plurality of trimming frames 11 to 13 displayed on the moving image, and the user can confirm the image shooting result and perform trimming by selecting a desired trimming frame. For example, when two or more trimming frames are selected, moving images trimmed at two or more aspect ratios of the respective trimming frames are obtained at a time.

In the above example, the video editing processing is performed by the PC 5. In the video production system 1, video editing processing similar to the above may be performed by the digital camera 100. In this case, the controller 135 of the digital camera 100 may acquire the moving image data recorded in the memory card 142 and perform processing similar to steps S32 to S34 controlling the display monitor 130 and the user interface 150.

### 2-6. Details of Setting Function in Digital Camera

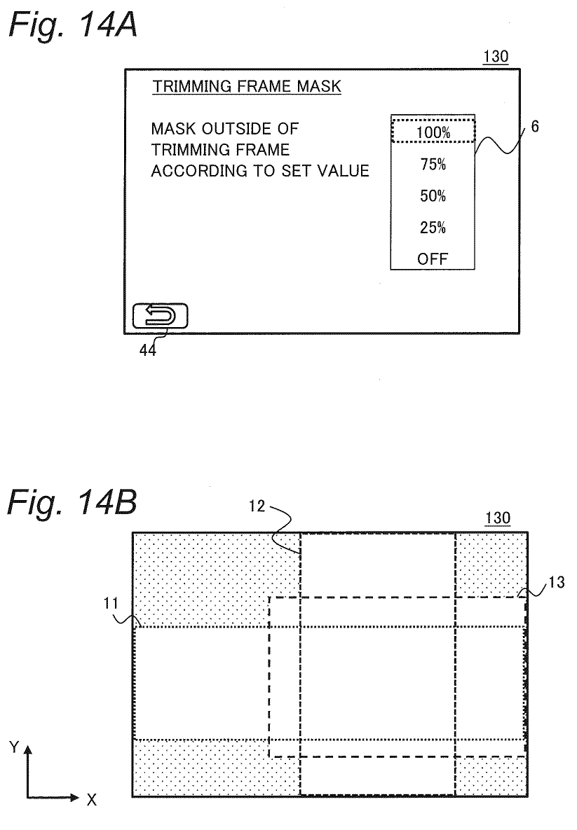

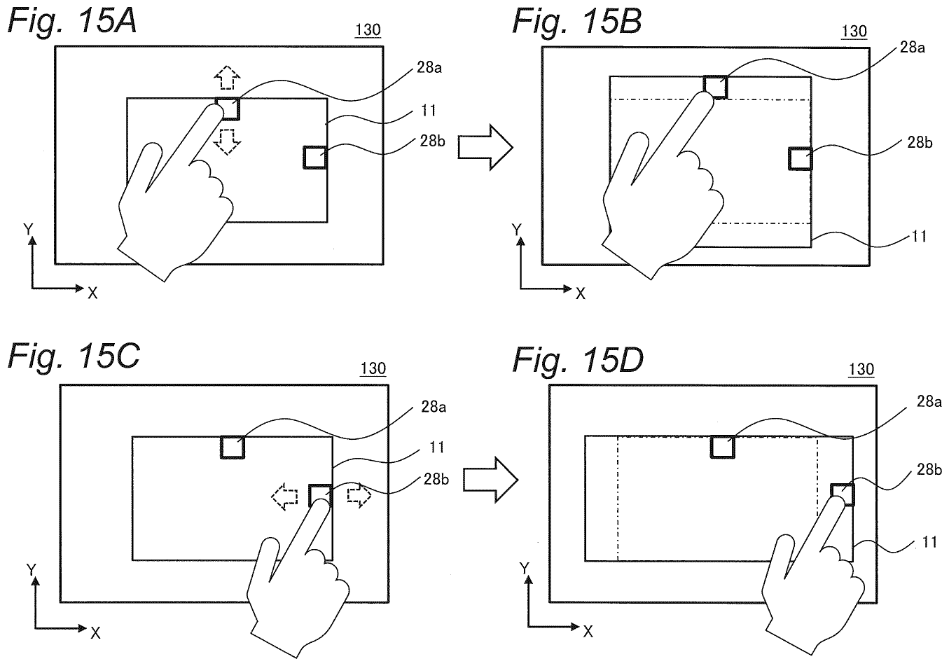

The digital camera 100 of the present embodiment further provides various functions for the user to easily adjust the trimming range as a setting function of the trimming frames 11 to 13 by the setting menu illustrated in FIG. 6. Details of such a setting function will be described with reference to FIGS. 14A, 14B and 15A to 15D.

FIG. 14 is a diagram for explaining a function of a trimming frame mask in the digital camera 100. FIG. 14A illustrates a setting screen that transitions when the menu item “trimming frame mask” is selected from the setting menu screen illustrated in FIG. 6A, for example. The digital camera 100 provides a masking function to mask an area outside the frames of the trimming frames 11 to 13 on the live view screen displayed on the display monitor 130, for example, in the image shooting mode.

On the setting screen illustrated in FIG. 14A, the display monitor 130 displays a selection list 6 in which options of concealment ratios of areas masked by the masking function are arranged, and the return button 44. Among the options in the selection list 6, “100%” indicates a state in which the background of the masked area is not transparent. “OFF” is an option of disabling the masking function corresponding to the concealment ratio “0%”.

FIG. 14B illustrates a display example of the display monitor 130 in the image shooting mode in a case where the masking function is set to be valid in addition to the trimming frames 11 to 13 similar to the example of FIG. 5. For example, as illustrated in FIG. 14B, the display monitor 130 masks an area that is not included in any range surrounded by each of the trimming frames 11 to 13 on the screen according to the set concealment ratio. According to such a masking function, the area to be trimmed by the trimming frames 11 to 13 can be more easily visually recognized by the user. For example, when the sizes and/or positions of the trimming frames 11 to 13 are changed by the size/position change processing (S12, S14), the masked area is also updated according to the change.

FIGS. 15A to 15D are diagrams for explaining a custom setting function of the aspect ratio in the digital camera 100. For example, when the menu item of “size/position setting” is selected on the setting screen (FIG. 6B) of the trimming frame 11 and the option of “custom” is selected from the selection list 4, the digital camera 100 causes the display monitor 130 to transition to the setting screen illustrated in FIG. 15.

In the example of FIG. 15, the display monitor 130 displays aspect operation areas 28a and 28b at the respective midpoints of the two sides of the trimming frame 11. For example, as illustrated in FIG. 15A, the controller 135 changes the aspect of the trimming frame 11 in the Y direction by a user operation of dragging the aspect operation area 28a in the Y direction on the touch panel 155. FIG. 15B illustrates an example in which the trimming frame 11 is enlarged in the Y direction from the state of FIG. 15A.

Furthermore, as illustrated in FIG. 15C, the controller 135 changes the aspect of the trimming frame 11 in the X direction by a user operation of dragging the aspect operation area 28b in the X direction. FIG. 15D illustrates an example in which the trimming frame 11 is enlarged in the X direction from the state of FIG. 15C.

According to the custom setting function of the aspect ratio as described above, the setting of each of the trimming frames 11 to 13 is not limited to the options included in the selection list 4 in advance, and the user can set a desired aspect ratio, and trimming according to the user's intention can be more easily performed.

### 3. Summary

As described above, in the present embodiment, the digital camera 100, which is an example of an imaging apparatus, includes the image sensor 115, which is an example of an image sensor that captures a subject image to generate image data, the controller 135, and the user interface 150. The controller 135 causes the display monitor 130 to display the captured image indicated by the image data, and controls image capturing. The user interface 150 inputs a user operation adjusting the trimming frames 11 to 13 indicating a range to be trimmed in the captured image (S2 to S5). The controller 135 sets the positions and sizes of the plurality of trimming frames 11 to 13 according to the user operation input via the user interface 150, the trimming frames 11 to 13 having respective aspect ratios, and causes the display monitor 130 to display the plurality of trimming frames at the set positions and sizes on the captured image (S1, S5).

According to the above digital camera 100, the plurality of trimming frames 11 to 13 having the respective aspect ratios are set according to the adjustment by the user, and are simultaneously displayed on the captured image such as the live view screen on the display monitor 130 (S1 to S5, see FIG. 7). In this way, the plurality of trimming frames 11 to 13 set according to the user operation is visualized on the captured image at their positions and sizes. Therefore, it is possible to facilitate image shooting for performing trimming at a plurality of aspect ratios from one image shooting result. For example, the user can perform adjustment confirming the relationship between the plurality of trimming frames 11 to 13 in their positions and sizes, and obtain an image trimmed to a desired composition in the aspect ratio of each of the trimming frames 11 to 13. In addition, each composition after such trimming can be visualized in the image shooting. This helps the trimming from the result of the image shooting.

In the present embodiment, the user interface 150 receives a touch operation on the captured image displayed on the display monitor 130. According to a first touch operation on a particular trimming frame in the plurality of trimming frames 11 to 13 displayed on the display monitor 130, the controller 135 updates at least one of the position and the size of the particular trimming frame (S2 to S5, S11 to S14). Therefore, the user can adjust the position and/or size of the trimming frame selected by the touch operation from the plurality of trimming frames 11 to 13, and the trimming frames 11 to 13 displayed on the live view screen or the like can be easily adjusted.

In the present embodiment, the controller 135 sets the AF target as an example of a focus target by AF control, which is an example of an autofocus operation in image shooting, according to a second touch operation on an area different from each of the trimming frames 11 to 13 on the captured image (S3, S7). Therefore, the AF control according to the touch operation on the subject or the like of the AF target and the size/position change processing (S5) according to the touch operation of each of the trimming frames 11 to 13 can be used in combination, by selectively performing each processing according to areas touched on the captured image (see S2 to S4).

In the present embodiment, the user interface 150 receives a prior user operation selecting the aspect ratio of each of the plurality of trimming frames 11 to 13 from the selection list 4 as an example of a plurality of options (see FIG. 6B). The controller 135 sets the position and size of a set trimming frame in the plurality of trimming frames 11 to 13, the set trimming frame having the aspect ratio which is set according to the user operation input via the user interface 150 (S1, S5, see FIGS. 6A and 6B). Therefore, the aspect ratios of the trimming frames 11 to 13 can be set by a user operation, and the position and size can be set to each of the trimming frames 11 to 13 having different aspect ratios, for example.

In the present embodiment, the controller 135 records moving image data as an example of image data indicating a result of image shooting in the memory card 142 as an example of a recording medium (S23). The moving image data recorded in the memory card 142 includes meta information managing the position and size set to each of the plurality of trimming frames 11 to 13 (see S22). Therefore, each of the trimming frames 11 to 13 whose position and size are set at the time of the image shooting can be recorded in the meta information in association with the image shooting result. According to such meta information, for example, the trimming frames 11 to 13 at the time of the image shooting can be reproduced on the captured image.

In the present embodiment, for example, similarly to the processing of step S34 of the video editing processing (FIG. 13) by the PC 5, the controller 135 generates the trimmed moving image data as an example of trimmed image data indicating an image trimmed according to one or more trimming frames from the image data indicating the result of the image shooting, based on the position and size set in each of the plurality of trimming frames 11 to 13. Therefore, a moving image trimmed at the position and size set to each of the trimming frames 11 to 13 can be generated from the image shooting result, and for example, trimming can be easily performed with a composition intended by the user at the time of the image shooting.

In the digital camera 100 of the present embodiment, the user interface 150 receives a touch operation on the captured image displayed on the display monitor 130. The controller 135 sets the position and size of the trimming frame 11 as an example of one or more trimming frames according to the user operation input via the user interface 150 (S5, see FIG. 6B), and displays the trimming frame 11 at the set position and size on the captured image on the display monitor 130 (S1, S5). According to a first touch operation on the trimming frame 11 displayed on the display monitor 130, the controller 135 updates at least one of the position and the size of the trimming frame 11 (S2 to S4, S11 to S14), and sets the AF target by AF control according to a second touch operation on an area different from the trimming frame 11 on the captured image (S3, S6 to S7). Therefore, the touch operation on the trimming frame on the image and the touch operation for the AF control can be used together.

In the present embodiment, the PC 5 is an example of a video editing apparatus. The PC 5 includes the device I/F 54 as an example of a communication circuitry and the controller 50. The device I/F 54 performs data communication with the digital camera 100 (an example of an imaging apparatus that captures a moving image). The controller 50 receives moving image data indicating a result of moving image capturing from the digital camera 100 via the device I/F 54 (S31), and causes the display 52 to display the moving image indicated by the received moving image data (S32). The received moving image data includes meta information managing the position and size set to each of the plurality of trimming frames 11 to 13 each indicating the range to be trimmed in the moving image (see S22). Based on the meta information, the controller 50 causes the display 52 to display a plurality of trimming frames 11 to 13 at set positions and sizes on the moving image (S32). Based on the position and size set to each of the plurality of trimming frames 11 to 13, the controller 50 generates trimmed moving image data as an example of trimmed moving image data indicating a moving image trimmed from the received moving image data according to one or more trimming frames (S33, S34).

According to the PC 5 described above, the trimming frames 11 to 13 set by the user at the time of shooting the moving image can be reproduced when playing the shot moving image based on the received meta information of the moving image data. Further, the trimmed moving image data can be generated by cutting out from the shot moving image according to one or more trimming frames among the trimming frames 11 to 13 displayed on the shot moving image. Therefore, after moving image shooting is performed, the user can confirm the trimming frames 11 to 13 recorded together with the moving image of the image shooting result, and further, the trimming according to the trimming frames 11 to 13 set at the time of the image shooting can be efficiently performed. As described above, the PC 5 of the present embodiment can support the trimming from the result of moving image shooting. Further, for example, even when the moving image is not edited by the digital camera 100, the trimming can be performed in the PC 5 according to the trimming frames 11 to 13 displayed at the time of the image shooting, based on the meta information of the moving image data. Such video post-production can facilitate the moving image shooting in the digital camera 100.

### Second Embodiment

The first embodiment has described the video production system 1 in which the size and position of the trimming frame 11 and the like are set according to the user operation before the moving image shooting operation in the digital camera 100, and the set size and position are recorded in association with the moving image of the image shooting result. The second embodiment further describes a video production system 1 capable of setting and recording the size and position of a trimming frame performing the moving image shooting operation in the digital camera 100.

Hereinafter, description of the configuration and operation similar to those of the video production system 1 according to the first embodiment will be omitted as appropriate, and the video production system 1 according to the present embodiment will be described.

### 1. Operation During Moving Image Shooting

In the video production system 1 of the present embodiment, the digital camera 100 displays the trimming frames 11 to 13 on the live view screen during execution of the moving image shooting operation, for example, similarly to the processing in the standby state for image shooting illustrated in FIG. 8, and performs the size/position change processing (S5) according to the user operation. The digital camera 100 of the present embodiment records trimming frame information in parallel with the processing in the capturing operation.

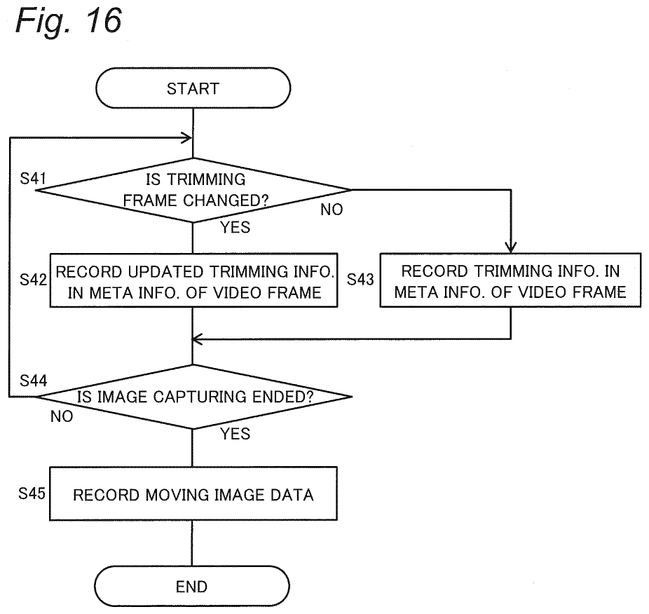

FIG. 16 is a flowchart illustrating recording processing in the digital camera 100 of the second embodiment. The processing of this flowchart is started together with the image shooting operation by the full-press operation of the release button 151, in a state in which the trimming frame information set at the time of the operation is held in the buffer memory 125. This processing is performed instead of the recording processing (FIG. 12) in the first embodiment, for example.

First, the controller 135 determines whether any of the trimming frames 11 to 13 is changed in the size/position change processing (S41). For example, when the size change operation is input (YES in S11 in FIG. 9) or the position change operation is input (YES in S13), the controller 135 may determine that the trimming frame is changed (YES in S41). The determination in step S41 is performed, for example, in a cycle in which the image data of each frame is generated corresponding to the frame rate.

When the trimming frame is changed (YES in S41), for example, the controller 135 records the trimming frame information updated according to the change, in the meta information on the latest frame image in the image shooting result obtained at the time of the change (S42). Such meta information of the moving image frame is recorded, for example, as header information for managing the position, size, and the like of the trimming frame at the frame level in the moving image data, in association with the frame image indicated by the image data of each frame.

When the trimming frame is not changed (NO in S41), the controller 135 records, for example, the trimming frame information held from the previous frame cycle in the meta information on the latest frame image (S43). In this case, trimming frame information similar to that of the previous frame image is recorded in the meta information of the frame image.

After the meta information of the trimming frame information is recorded (S42, S43), the controller 135 determines whether or not the moving image shooting is ended similarly to step S21 in FIG. 12, for example (S44). When the moving image shooting is not ended (NO in S44), the controller 135 repeats the processing in and after step S41.

When the moving image shooting is ended (YES in S44), the controller 135 generates the moving image data to include the meta information of each frame image, and records the generated moving image data in the memory card 142 (S45). Thereafter, the controller 135 ends the processing of this flowchart.

According to the above processing, even when the sizes and/or positions of the trimming frames 11 to 13 are changed when performing the moving image shooting, the moving image data including the trimming frame information in the meta information can be recorded in association with each frame image. Therefore, for example, by the trimming frame whose size is changed in moving image shooting, the size of the subject changes in respective frame images each obtained at a constant size from the image shooting result, and this can give a pseudo zoom effect. Furthermore, by the trimming frame whose position is changed in the moving image shooting, the position of the subject changes in respective frame images obtained from the image shooting result, according to the change of the trimming frame, and this can give a pseudo pan effect.

For example, assuming a case where a moving image of a stage is shot from a guest seat, shooting may be started at a relatively wide angle for the entire stage, and a performer may move to a corner of the stage. The position and/or size of the trimming frame may be changed in such moving image shooting. In such an application, the moving image shooting may be performed in a state where the digital camera 100 is fixed by a tripod or the like. Even in a case where moving image shooting is performed in a state where the user holds the digital camera 100, a size/position change operation can be input with the selection buttons 152, the dial 154, and the like, and camera shake during capturing can be suppressed. The digital camera 100 may include an electronic viewfinder (EVF), and display similar to the display monitor 130 may be performed on the EVF in such hand-held imaging or the like. Furthermore, in an external electronic device such as a smartphone capable of data communication with the digital camera 100, a size/position change operation by a touch operation may be input while displaying a live view screen.

The example in which the digital camera 100 performs the size/position change processing when displaying the plurality of trimming frames 11 to 13 is described above. In the present embodiment, the digital camera 100 may perform the size/position change processing when displaying one trimming frame.

### 2. Operation after Capturing Moving Image

An operation performed after the above recording processing in the present system 1 will be described below. The present system 1 reproduces, for example, a captured moving image by the digital camera 100 in the PC 5. In the present embodiment, the PC 5 performs an operation enabling the user to adjust the trimming frame recorded for each frame image of the moving image in such moving image reproduction processing.

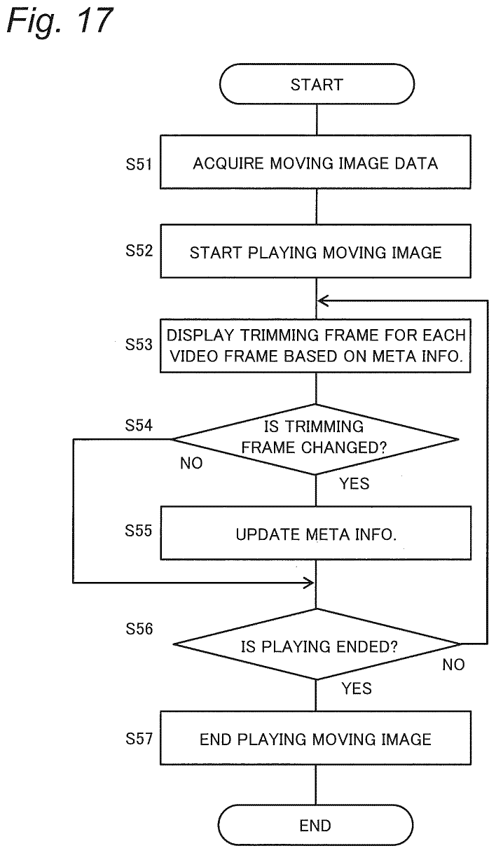

FIG. 17 is a flowchart illustrating a moving image reproduction processing in the PC 5 of the second embodiment. The processing of this flowchart is started according to a predetermined user operation for causing the PC 5 to reproduce a moving image, for example. Each processing in FIG. 17 is performed by the controller 50 of the PC 5.

First, the controller 50 acquires moving image data from the digital camera 100 via the device I/F 54, for example, similarly to step S31 in FIG. 13 (S51).

Next, the controller 50 starts reproduction of a moving image indicated by the moving image data on the display 52 based on the acquired moving image data (S52).

For example, based on the meta information recorded for each frame image in the moving image data, the controller 50 superimposes the trimming frames 11 to 13 in the meta information on the frame image and displays the frame image on the display 52 (S53).

For example, the controller 50 determines whether each trimming frame is changed from the trimming frame information recorded in the meta information according to whether the user operation to change the size and/or position of any of the trimming frames 11 to 13 is input in the user interface 53 (S54). For example, the user operation may be an operation of dragging the frame line or vertex of any of the trimming frames 11 to 13 displayed on the display 52 with a mouse or the like in the user interface 53. Such a user operation may be input in a state where the reproduction of the moving image is temporarily stopped.

When the trimming frame is changed (YES in S54), according to the changed size and position, the controller 50 updates the meta information on the frame image, in which the trimming frame is changed, in the moving image data (S55).

On the other hand, when the trimming frame is not changed (NO in S54), the controller 50 does not update the meta information (S55), and proceeds to next step S56.

The controller 50 determines whether or not to end the reproduction of the moving image, for example, based on whether or not the moving image data is read up to the last frame image (S56). The controller 50 may further make the determination in step S56 according to whether or not a user operation for ending the reproduction is input on the user interface 53. The determination in step S56 is performed in a cycle corresponding to the frame rate of the moving image, for example.

When the reproduction of the moving image is not ended (NO in S56), the controller 50 repeats the processing in and after step S53.

When the reproduction of the moving image is ended (YES in S56), the controller 50 ends the reproduction of the moving image (S57), and ends the processing of this flowchart.

According to the above processing, the trimming frame recorded in the meta information for each frame image of the moving image data is displayed at the time of reproducing the moving image, and the sizes and/or positions of the trimming frames 11 to 13 in each frame image can be changed according to the user operation. Furthermore, a result of such a change is reflected in the meta information for each frame image. Therefore, in the present system 1, after shooting a moving image, the size and position of each of the trimming frames 11 to 13 displayed at the time of the shooting can be adjusted, by the user confirming each of the trimming frames 11 to 13. For example, the user can finely adjust the trimming frames 11 to 13 when reproducing the moving image, and the intended trimming can be more easily performed.

The above processing may be performed, for example, before the video editing processing (FIG. 13) described in the first embodiment. Furthermore, processing similar to the above may be performed by the digital camera 100. In this case, the digital camera 100 may acquire the moving image data from the memory card 142, and perform the size/position change processing according to the touch operation of each of the trimming frames 11 to 13, for example, similarly to the operation in the standby state for image shooting, after the start of the reproduction of the moving image.

### 3. Modifications

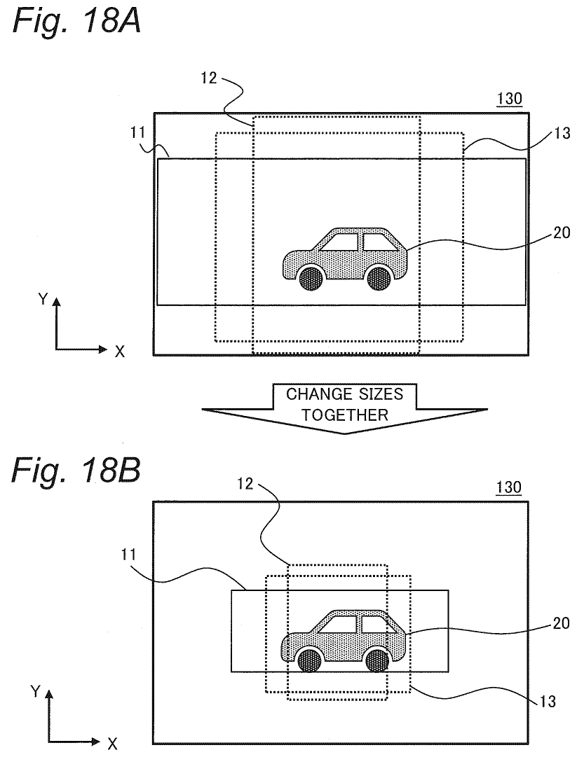

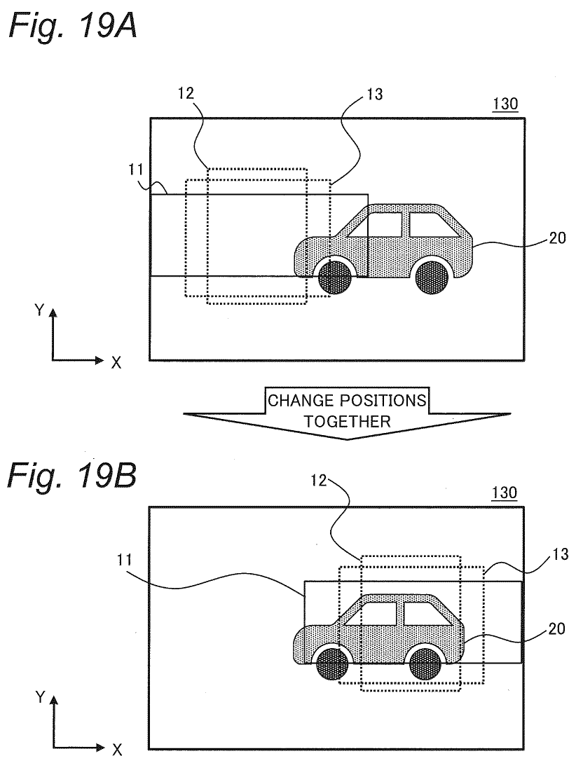

An example in which the size and position of one trimming frame selected from the plurality of trimming frames 11 to 13 can be changed is described above. In the present system 1, the sizes and/or positions of the plurality of trimming frames 11 to 13 may be collectively changed by a user operation for one trimming frame. A first modification of the second embodiment in which the size change and the position change in the plurality of trimming frames 11 to 13 are associated will be described with reference to FIGS. 18A, 18B, 19A and 19B.

FIGS. 18A and 18B are diagrams for explaining association of size change in a plurality of trimming frames according to the present modification. For example, in the moving image shooting operation, the digital camera 100 of the present embodiment displays the plurality of set trimming frames 11 to 13 on the display monitor 130 similarly to step S1 of FIG. 8. FIG. 18A illustrates a display example of the live view screen on the display monitor 130. Hereinafter, an example in which the trimming frame 11 is selected by a touch operation of a frame line will be described.

The digital camera 100 receives a size change operation and a position change operation on the selected trimming frame 11, for example, similarly to steps S11 and S13 of the size/position change processing (FIG. 9). In the digital camera 100 of this example, when the size/position change operation on the trimming frame 11 is input instead of steps S12 and S14 in FIG. 9, the sizes/positions of the other trimming frames 12 and 13 are changed in association with the trimming frame 11.

FIG. 18B illustrates a display example of the live view screen in a case where the size change operation is input for the trimming frame 11 from the example of FIG. 18A. In this example, the controller 135 of the digital camera 100 changes the size of each of the plurality of trimming frames 11 to 13 such that magnifications at which the sizes are changed from the initial state according to the size change operation coincide with each other in the plurality of trimming frames 11 to 13.

FIGS. 19A and 19B are diagrams for explaining association of position change in a plurality of trimming frames according to the present modification. FIG. 19A illustrates an example in which the trimming frames 11 to 13 are displayed on the live view screen different from that of FIG. 18A on the display monitor 130. FIG. 19B illustrates a display example of the live view screen in a case where the position change operation is input for the trimming frame 11 from the example of FIG. 19A. In the present example, the controller 135 changes the positions of the plurality of trimming frames 11 to 13 so that movement amounts in the X direction and the Y direction from the reference point coincide with each other.

Further, in the recording processing of this example, instead of step S42 of FIG. 16, the controller 135 records the updated trimming frame information on all trimming frames 11 to 13 in the meta information.

According to the above operation of the digital camera 100, for example, the size and position of each of the plurality of trimming frames 11 to 13 can be collectively changed by the size/position change operation on one trimming frame 11. Therefore, for example, even in a case where moving images of a plurality of aspect ratios are trimmed for various platforms by the trimming frames 11 to 13 from one moving image, the zoom effect by the similar size change and the pan effect by the position change can be applied to the moving images of the respective aspect ratios at a time.

In the above description, the operation of the digital camera 100 that changes the sizes/positions of the plurality of trimming frames 11 to 13 in association with each other is exemplified. Such an operation may be performed in the PC 5. For example, when a user operation of changing the size and/or position of any of the trimming frames 11 to 13 is input in the moving image reproduction processing (FIG. 17) (YES in S54), the PC 5 may update the meta information for all the trimming frames 11 to 13 instead of step S55.

### 4. Summary

As described above, in the digital camera 100 of the present embodiment, the controller 135 changes the position and size of one or more trimming frames in the plurality of trimming frames 11 to 13 according to the user operation input via the user interface 150, the trimming frames 11 to 13 being displayed on the display monitor 130, with moving image shooting being performed, the moving image shooting causing the image sensor 115 captures a subject image in a predetermined frame cycle (see S1 to S5, S41 to S44). Therefore, in the moving image shooting, user adjustment of the positions and sizes of the plurality of displayed trimming frames 11 to 13 can be reflected in real time, and the moving image shooting of a moving image to be trimmed can be facilitated.

In the present embodiment, the controller 135 records moving image data indicating a result of the moving image shooting in the memory card 142 as an example of a recording medium (S45). The moving image data recorded in the memory card 142 includes meta information managing the position and size set to each of the plurality of trimming frames 11 to 13 for each frame cycle (see S42, S43). Therefore, the position and size set for each frame of the moving image can be recorded in the meta information, and for example, a moving image to which a video effect such as a pan effect and a zoom effect is added can be obtained by trimming at the position and size that change in each frame based on the meta information.

In the present embodiment, with the moving image shooting being performed, the controller 135 changes one trimming frame in the plurality of trimming frames 11 to 13 according to the user operation input via the user interface 150, and changes other trimming frames to maintain respective positional and size relationships with the one trimming frame (see FIGS. 18A to 19B). Therefore, it is possible to easily apply the same pan effect/zoom effect to the moving image to be trimmed by each trimming frame, for example, by associating adjustments of the positions/sizes by the user operation in the plurality of trimming frames 11 to 13.

The PC 5 of the present embodiment further includes the user interface 53 for inputting a user operation adjusting the trimming frames 11 to 13. The meta information in the present embodiment manages the position and size set to each of the plurality of trimming frames 11 to 13 for each frame cycle in which the digital camera 100 captures the moving image, as an example of the imaging apparatus (see S42, S43). When playing the moving image by displaying the moving image on the display 52 (S52), the controller 50 of the PC 5 changes one or more trimming frames in the plurality of trimming frames 11 to 13 displayed on the display 52, according to the user operation input via the user interface 53 (S53, S54), and updates the position and size of the changed trimming frames in the meta information (S55). Therefore, in the PC 5, the position and size of the trimming frame can be changed in real time according to the user operation when playing the moving image based on the meta information in which the position and size of each of the trimming frames 11 to 13 are managed for each frame of the moving image data.

The digital camera 100 of the present embodiment is an example of an imaging apparatus that captures a moving image. The digital camera 100 includes the image sensor 115 as an example of an image sensor that captures a subject image at a predetermined frame cycle to generate image data, the controller 135, and the user interface 150. The controller 135 causes the display monitor 130 as an example of a display to display the captured image indicated by the image data, and controls moving image shooting by the digital camera 100. The user interface 150 inputs a user operation adjusting the trimming frames 11 to 13 indicating a range trimmed in the captured image (S2 to S5). With the moving image shooting being performed, the controller 135 causes the display monitor 130 to display a plurality of trimming frames 11 to 13 superimposed on the captured image, and changes positions and sizes of one or more trimming frames in the plurality of trimming frames 11 to 13 displayed on the display monitor 130 according to the user operation input via the user interface 150 (see S1 to S5, S41 to S44). As described above, in the moving image shooting, the adjustment of the position and the size by the user operation can be reflected in real time in the plurality of displayed trimming frames 11 to 13.

### Other Embodiments

As described above, the first and second embodiments have been described as examples of the technique disclosed in the present application. However, the technique in the present disclosure is not limited thereto, and can also be applied to embodiments in which changes, substitutions, additions, omissions, and the like are made as appropriate. Further, a new embodiment can be made by combining the components described in the first and second embodiments. Thus, in the following, other embodiments will be exemplified.

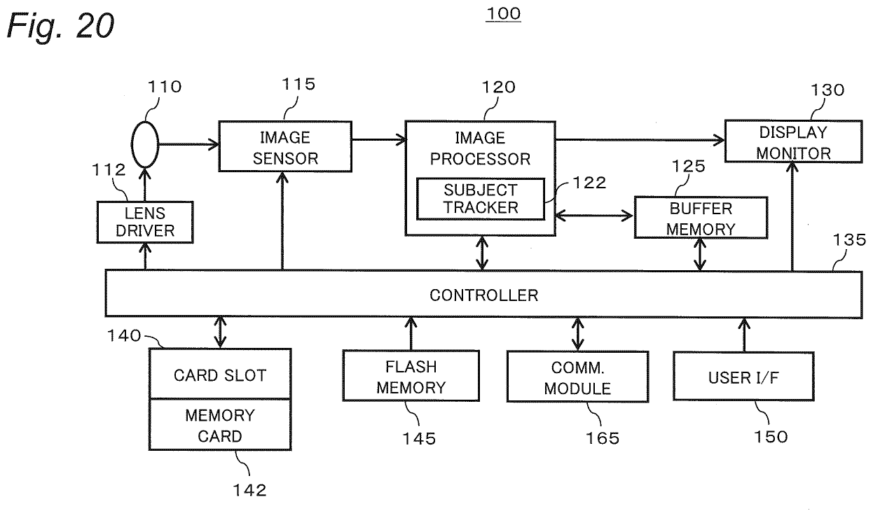

In the second embodiment described above, an example is described in which the sizes and/or positions of the plurality of displayed trimming frames 11 to 13 are changed according to the user operation in moving image shooting by the digital camera 100. Such size change/position change of each of the trimming frames 11 to 13 is not limited to the user operation, and may be automatically performed, for example, according to a subject of the subject image captured in the digital camera 100. Such a second modification of the second embodiment will be described with reference to FIG. 20.

FIG. 20 is a diagram illustrating a configuration of a digital camera 100 according to the present modification. In addition to the configuration similar to the example of FIG. 2, the digital camera 100 of the present modification includes, for example, a subject tracker 122 that tracks a subject on an image in moving image shooting as a functional configuration of the image processing engine 120. The subject tracker 122 may be realized by executing a predetermined program by the controller 135, or may be realized as a dedicated hardware circuit. The subject tracker 122 recognizes a subject in an image, determines a moving direction of the subject between frame images, and the like, and tracks the subject, for example, similarly to a known technique disclosed in JP 2008-288797 A. For example, the tracking result by the subject tracker 122 includes the position, size, and the like at which the subject set as an object to be tracked is recognized in each frame image.

In the present modification, in moving image shooting, for example, similarly to step S1 in FIG. 8, the controller 135 of the digital camera 100 displays the plurality of trimming frames 11 to 13 in which the aspect ratio is set by the user operation in the setting function on the live view screen in the initial state. The controller 135 changes the position and/or size of one or more trimming frames in the trimming frames 11 to 13 according to the tracking result by the subject tracker 122, for example, instead of the size/position change processing (S5) by the user operation. For example, for each trimming frame selected by a user operation, the changed position and size can be set based on the tracking result of the subject similarly to JP 2008-288797 A, and may be changed in association in a plurality of trimming frames similarly to the first modification.

As described above, the digital camera 100 of the present modification further includes the subject tracker 122 that is an example of a tracker that tracks a subject indicated by a subject image in the moving image shooting. With the moving image shooting performed, the controller 135 causes the display monitor 130 to display the plurality of trimming frames 11 to 13 superimposed on the captured image, and changes one or more trimming frames in the plurality of trimming frames 11 to 13 displayed on the display monitor 130, according to the position and size of the subject tracked by the subject tracker 122 in the captured image. Therefore, in the moving image shooting, the positions and sizes of the plurality of displayed trimming frames 11 to 13 can be adjusted in real time according to the tracking result of the subject by the subject tracker 122.

In each of the above embodiments, an example is described in which a moving image edited by the PC 5 from moving image data captured by the digital camera 100 is uploaded to a platform such as various kinds of social media. In the present embodiment, for example, a moving image edited by the camera 100 may be uploaded.

In each of the above embodiments, an example is described in which the moving image data, the trimming frames 11 to 13, and the like are displayed on the display monitor 130 of the digital camera 100 and the display 52 of the PC 5. In the present embodiment, in the digital camera 100, for example, an external display device may be connected via the communication module 165, and the controller 135 may control the display device to perform various displays. Also in the PC 5, an external display device may be connected via the device I/F 54 or the like, and the controller 50 may control the display device to perform various displays.

In the first embodiment described above, the example in which the PC 5 generates the trimmed moving image data from one moving image captured by the digital camera 100 based on the meta information of the moving image data is described (FIG. 13). In the present embodiment, the digital camera 100 may generate a trimmed moving image and record the trimmed moving image in the memory card 142, for example, after a moving image shooting operation. Furthermore, in a case where a plurality of memory cards can be attached to the digital camera 100, for example, each trimmed moving image data according to the plurality of trimming frames 11 to 13 may be recorded in a different memory card.

In the second embodiment described above, the frame-level header information is described as the meta information for recording the trimming frame information for each frame image in the moving image data. In the present embodiment, for example, the trimming frame information may be managed separately from the moving image data in association with the frame image, and the header information or the like of the entire moving image data may include information for identifying the trimming frames 11 to 13 in such external management information.

Furthermore, in the above embodiments, the digital camera is described as an example of the imaging apparatus, but the imaging apparatus is not limited thereto. The imaging apparatus of the present disclosure may be an electronic device having an imaging function (e.g., a video camera, a smartphone, a tablet terminal, or the like).

### Aspect Examples

Hereinafter, various aspects of the present disclosure will be exemplified.

A first aspect according to the present disclosure is an imaging apparatus including: an image sensor that captures a subject image to generate image data; a controller that causes a display to display a captured image indicated by the image data to control image shooting; and a user interface that inputs a user operation adjusting a trimming frame indicating a range to be trimmed in the captured image. The controller sets positions and sizes of a plurality of trimming frames according to the user operation input via the user interface, the plurality of trimming frames having respective aspect ratios, and displays the plurality of trimming frames at the set positions and sizes on the captured image on the display.

A second aspect is the imaging apparatus according to the first aspect, wherein the user interface receives a touch operation on the captured image displayed on the display, and the controller updates at least one of a position or a size of a particular trimming frame in the plurality of trimming frames displayed on the display, according to a first touch operation on the particular trimming frame.

A third aspect is the imaging apparatus according to the second aspect, wherein the controller sets a focus target by an autofocus operation in the image shooting according to a second touch operation on an area different from each of the trimming frames on the captured image.

A fourth aspect is the imaging apparatus according to any of the first to third aspects, wherein the user interface receives a prior user operation selecting an aspect ratio of each of the plurality of trimming frames from a plurality of options, and the controller sets a position and a size of a set trimming frame in the plurality of trimming frames, the set trimming frame having the aspect ratio which is set according to the prior user operation input via the user interface.

A fifth aspect is the imaging apparatus according to any of the first to fourth aspects, wherein the controller records image data indicating a result of the image shooting on a recording medium, and the image data recorded on the recording medium includes meta information managing a position and a size set to each of the plurality of trimming frames.

A sixth aspect is the imaging apparatus according to any of the first to fifth aspects, wherein the controller generates trimmed image data based on a position and a size set to each of the plurality of trimming frames, the trimmed image data indicating an image trimmed according to one or more trimming frames in the plurality of trimming frames from image data indicating a result of the image shooting.

A seventh aspect is the imaging apparatus according to any of the first to sixth aspects, wherein the controller changes positions and sizes of one or more trimming frames in the plurality of trimming frames according to the user operation input via the user interface, the plurality of trimming frames being displayed on the display, with moving image shooting being performed, the moving image shooting causing the image sensor to capture the subject image at a predetermined frame cycle.

A eighth aspect is the imaging apparatus according to the seventh aspect, wherein the controller changes positions and sizes of one or more trimming frames in the plurality of trimming frames according to the user operation input via the user interface, the plurality of trimming frames being displayed on the display, with moving image shooting being performed, the moving image shooting causing the image sensor to capture the subject image at a predetermined frame cycle.

A nineth aspect is the imaging apparatus according to the seventh or eighth aspect, wherein the controller changes one trimming frame in the plurality of trimming frames according to the user operation input via the user interface with the moving image shooting being performed, and changes other trimming frames to maintain respective positional and size relationships with the one trimming frame.

A tenth aspect is an imaging apparatus including: an image sensor that captures a subject image to generate image data; a controller causes a display to display a captured image indicated by the image data to control image shooting; and a user interface that inputs a user operation adjusting a trimming frame indicating a range to be trimmed in the captured image. The user interface receives a touch operation on the captured image displayed on the display. The controller sets positions and sizes of one or more trimming frames according to the user operation input via the user interface. The controller displays the one or more trimming frames at the set positions and sizes on the captured image on the display. The controller updates at least one of a position or a size of a particular trimming frame of the one or more trimming frames displayed on the display, according to a first touch operation on the particular trimming frame. The controller sets a focus target by an autofocus operation in the image shooting according to a second touch operation on an area different from the one or more trimming frames on the captured image.

A eleventh aspect is a video editing apparatus including: a communication circuitry that performs data communication with an imaging apparatus that captures a moving image; and a controller that receives moving image data indicating a result of moving image shooting from the imaging apparatus via the communication circuitry and causes a display to display the moving image indicated by the received moving image data. The received moving image data includes meta information managing a position and a size set to each of a plurality of trimming frames each indicating a range to be trimmed in the moving image. The controller causes the display to display the plurality of trimming frames on the moving image at the position and size set to each of the plurality of trimming frames, based on the meta information. The controller generates trimmed moving image data based on the position and the size set to each of the plurality of trimming frames, the trimmed moving image data indicating a moving image trimmed according to one or more trimming frames in the plurality of the trimming frames from the received moving image data.

A twelfth aspect is the video editing apparatus according to the eleventh aspect, further comprising a user interface that inputs a user operation adjusting the trimming frame. The meta information manages the position and the size set to each of the plurality of trimming frames for each frame cycle in which the moving image is captured by the imaging apparatus. The controller changes one or more trimming frames in the plurality of trimming frames according to the user operation input via the user interface, the plurality of trimming frames being displayed on the display, when playing the moving image by displaying the moving image on the display. The controller updates positions and sizes of the changed trimming frames in the meta information.

A thirteenth aspect is an imaging apparatus that captures a moving image. The imaging apparatus includes: an image sensor that captures a subject image at a predetermined frame cycle to generate image data; a controller that causes a display to display a captured image indicated by the image data to control moving image shooting by the imaging apparatus; and a user interface that inputs a user operation adjusting a trimming frame indicating a range to be trimmed in the captured image. The controller causes the display to display a plurality of trimming frames superimposed on the captured image with the moving image shooting being performed, and changes one or more trimming frames in the plurality of trimming frames displayed on the display, according to the user operation input via the user interface.

A fourteenth aspect is the imaging apparatus according to the thirteenth aspect, wherein the controller changes one trimming frame in the plurality of trimming frames according to the user operation input via the user interface with the moving image shooting being performed, and changes other trimming frames to maintain respective positional and size relationships with the one trimming frame.

A fifteenth aspect is an imaging apparatus that captures a moving image. The imaging apparatus includes: an image sensor that captures a subject image at a predetermined frame cycle to generate image data; a controller that causes a display to display a captured image indicated by the image data to control moving image shooting by the imaging apparatus; a user interface that inputs a user operation adjusting a trimming frame indicating a range to be trimmed in the captured image; and a tracker that tracks a subject indicated by the subject image in the moving image shooting. The controller causes the display to display a plurality of trimming frames superimposed on the captured image with the moving image shooting being performed, and changes one or more trimming frames in the plurality of trimming frames displayed on the display, according to a position and a size of the subject tracked by the tracker in the captured image.

As described above, the embodiments have been described as examples of the technique in the present disclosure. For this purpose, the accompanying drawings and the detailed description have been provided.

Accordingly, some of the constituent elements described in the accompanying drawings and the detailed description may also include constituent elements that are not indispensable for solving the problem in order to exemplify the above technique in addition to indispensable constituent elements for solving the problem. Therefore, these constituent elements that are not indispensable are not to be immediately recognized to be indispensable on the basis of the fact that these constituent elements that are not indispensable are described in the accompanying drawings or the detailed description.

In addition, since the above-described embodiments are intended to exemplify the technique in the present disclosure, it is possible to make various changes, replacements, additions, omissions, and the like within the scope of claims or the equivalent thereof.

The present disclosure is applicable to various imaging apparatus that capture images to be trimmed and various video editing apparatus that trim the captured images.

1. An imaging apparatus comprising:
an image sensor that captures a subject image to generate image data;
a controller that causes a display to display a captured image indicated by the image data to control image shooting; and
a user interface that inputs a user operation adjusting a trimming frame indicating a range to be trimmed in the captured image,
wherein the controller
sets positions and sizes of a plurality of trimming frames according to the user operation input via the user interface, the plurality of trimming frames having respective aspect ratios, and
displays the plurality of trimming frames at the set positions and sizes on the captured image on the display.

2. The imaging apparatus according to claim 1, wherein
the user interface receives a touch operation on the captured image displayed on the display, and
the controller updates at least one of a position or a size of a particular trimming frame in the plurality of trimming frames displayed on the display, according to a first touch operation on the particular trimming frame.

3. The imaging apparatus according to claim 2, wherein the controller sets a focus target by an autofocus operation in the image shooting according to a second touch operation on an area different from each of the trimming frames on the captured image.

4. The imaging apparatus according to claim 1, wherein
the user interface receives a prior user operation selecting an aspect ratio of each of the plurality of trimming frames from a plurality of options, and
the controller sets a position and a size of a set trimming frame in the plurality of trimming frames, the set trimming frame having the aspect ratio which is set according to the prior user operation input via the user interface.

5. The imaging apparatus according to claim 1, wherein
the controller records image data indicating a result of the image shooting on a recording medium, and
the image data recorded on the recording medium includes meta information managing a position and a size set to each of the plurality of trimming frames.

6. The imaging apparatus according to claim 1, wherein the controller generates trimmed image data based on a position and a size set to each of the plurality of trimming frames, the trimmed image data indicating an image trimmed according to one or more trimming frames in the plurality of trimming frames from image data indicating a result of the image shooting.

7. The imaging apparatus according to claim 1, wherein the controller changes positions and sizes of one or more trimming frames in the plurality of trimming frames according to the user operation input via the user interface, the plurality of trimming frames being displayed on the display, with moving image shooting being performed, the moving image shooting causing the image sensor to capture the subject image at a predetermined frame cycle.

8. The imaging apparatus according to claim 7, wherein
the controller records moving image data indicating a result of the moving image shooting on a recording medium, and
the moving image data recorded on the recording medium includes meta information managing a position and a size set to each of the plurality of trimming frames for each frame cycle.

9. The imaging apparatus according to claim 7, wherein the controller changes one trimming frame in the plurality of trimming frames according to the user operation input via the user interface with the moving image shooting being performed, and changes other trimming frames to maintain respective positional and size relationships with the one trimming frame.

10. An imaging apparatus comprising:
an image sensor that captures a subject image to generate image data;
a controller causes a display to display a captured image indicated by the image data to control image shooting; and
a user interface that inputs a user operation adjusting a trimming frame indicating a range to be trimmed in the captured image, wherein
the user interface receives a touch operation on the captured image displayed on the display, and
the controller
sets positions and sizes of one or more trimming frames according to the user operation input via the user interface,
displays the one or more trimming frames at the set positions and sizes on the captured image on the display,
updates at least one of a position or a size of a particular trimming frame of the one or more trimming frames displayed on the display, according to a first touch operation on the particular trimming frame, and
sets a focus target by an autofocus operation in the image shooting according to a second touch operation on an area different from the one or more trimming frames on the captured image.

11. A video editing apparatus comprising:
a communication circuitry that performs data communication with an imaging apparatus that captures a moving image; and
a controller that receives moving image data indicating a result of moving image shooting from the imaging apparatus via the communication circuitry and causes a display to display the moving image indicated by the received moving image data, wherein
the received moving image data includes meta information managing a position and a size set to each of a plurality of trimming frames each indicating a range to be trimmed in the moving image, and
the controller
causes the display to display the plurality of trimming frames on the moving image at the position and the size set to each of the plurality of trimming frames, based on the meta information, and
generates trimmed moving image data based on the position and the size set to each of the plurality of trimming frames, the trimmed moving image data indicating a moving image trimmed according to one or more trimming frames in the plurality of the trimming frames from the received moving image data.

12. The video editing apparatus according to claim 11, further comprising a user interface that inputs a user operation adjusting the trimming frame, wherein
the meta information manages the position and the size set to each of the plurality of trimming frames for each frame cycle in which the moving image is captured by the imaging apparatus, and
the controller changes one or more trimming frames in the plurality of trimming frames according to the user operation input via the user interface, the plurality of trimming frames being displayed on the display, when playing the moving image by displaying the moving image on the display, and
updates positions and sizes of the changed trimming frames in the meta information.

13. An imaging apparatus that captures a moving image, the imaging apparatus comprising:
an image sensor that captures a subject image at a predetermined frame cycle to generate image data;
a controller that causes a display to display a captured image indicated by the image data to control moving image shooting by the imaging apparatus; and
a user interface that inputs a user operation adjusting a trimming frame indicating a range to be trimmed in the captured image,
wherein the controller
causes the display to display a plurality of trimming frames superimposed on the captured image with the moving image shooting being performed, and
changes one or more trimming frames in the plurality of trimming frames displayed on the display, according to the user operation input via the user interface.

14. The imaging apparatus according to claim 13, wherein the controller changes one trimming frame in the plurality of trimming frames according to the user operation input via the user interface with the moving image shooting being performed, and changes other trimming frames to maintain respective positional and size relationships with the one trimming frame.

15. An imaging apparatus that captures a moving image, the imaging apparatus comprising:
an image sensor that captures a subject image at a predetermined frame cycle to generate image data;
a controller that causes a display to display a captured image indicated by the image data to control moving image shooting by the imaging apparatus;
a user interface that inputs a user operation adjusting a trimming frame indicating a range to be trimmed in the captured image; and
a tracker that tracks a subject indicated by the subject image in the moving image shooting,
wherein the controller
causes the display to display a plurality of trimming frames superimposed on the captured image with the moving image shooting being performed, and
changes one or more trimming frames in the plurality of trimming frames displayed on the display, according to a position and a size of the subject tracked by the tracker in the captured image.
